(19) United States
(12) Patent Application Publication
(10) Pub. No.: US 2026/0259712 A1
(43) Pub. Date: Sep. 3, 2026

(54) INFORMATION PROCESSING DEVICE, INFORMATION PROCESSING METHOD, AND NON-TRANSITORY COMPUTER-READABLE STORAGE MEDIUM

(71) Applicant: NEC Corporation, Tokyo (JP)

(72) Inventor: Osamu DAIDO, Tokyo (JP)

(73) Assignee: NEC Corporation, Tokyo (JP)

(21) Appl. No.: 19/456,214

(22) Filed: Jan. 22, 2026

(30) Foreign Application Priority Data
Feb. 28, 2025 (JP) 2025-031784

(51) Int. Cl. G06F 8/41

(52) U.S. Cl. CPC G06F 8/433

(57) ABSTRACT

An information processing device includes a variable detection means for performing a process of detecting, from a current position, an evaluation target variable at the current position in a case where it is determined that an entire exception handling block is present on a side in a progressing direction of program execution with respect to the current position in program execution by a lazy evaluation method or the current position is located within an exception detection target portion of the exception handling block, and an evaluation means for evaluating a variable in a case where the evaluation target variable is detected.

This application is based upon and claims the benefit of priority from Japanese Patent Application No. 2025-031784, filed on Feb. 28, 2025, the disclosure of which is incorporated herein in its entirety by reference.

### TECHNICAL FIELD

The present disclosure relates to an information processing device, an information processing method, and a program.

### BACKGROUND ART

An exception handling may be taken when a program is executed (see, for example, JP 2008-537245 A).

### SUMMARY

According to a first aspect of the present disclosure, an information processing device includes a variable detection means for performing a process of detecting, from a current position, an evaluation target variable at the current position in a case where it is determined that an entire exception handling block is present on a side in a progressing direction of program execution with respect to the current position in program execution by a lazy evaluation method or the current position is located within an exception detection target portion of the exception handling block, and an evaluation means for evaluating a variable in a case where the evaluation target variable is detected.

According to a second aspect of the present disclosure, an information processing method causes a computer to execute performing a process of detecting, from a current position, an evaluation target variable at the current position in a case where it is determined that an entire exception handling block is present on a side in a progressing direction of program execution with respect to the current position in program execution by a lazy evaluation method or the current position is located within an exception detection target portion of the exception handling block, and evaluating a variable in a case where the evaluation target variable is detected.

According to a third aspect of the present disclosure, a program causes a computer to execute performing a process of detecting, from a current position, an evaluation target variable at the current position in a case where it is determined that an entire exception handling block is present on a side in a progressing direction of program execution with respect to the current position in program execution by a lazy evaluation method or the current position is located within an exception detection target portion of the exception handling block, and evaluating a variable in a case where the evaluation target variable is detected.

### BRIEF DESCRIPTION OF THE DRAWINGS

FIG. 1 is a diagram illustrating an example of a configuration of an information processing device according to at least one example embodiment;

FIG. 2 is a diagram illustrating a first example of a source program including exception handling;

FIG. 3 is a diagram illustrating a second example of a source program including exception handling;

FIG. 4 is a diagram illustrating an example of data input and output in each unit of a front-end unit according to at least one example

embodiment;

FIG. 5 is a diagram illustrating a third example of a source program including exception handling;

FIG. 6 is a diagram illustrating a fourth example of a source program including exception handling;

FIG. 7 is a diagram illustrating a first example of a configuration of a bytecode inspection unit according to at least one example embodiment;

FIG. 8 is a diagram illustrating a fifth example of a source program including exception handling;

FIG. 9 is a diagram illustrating a second example of a configuration of a bytecode inspection unit according to at least one example embodiment;

FIG. 10 is a diagram illustrating a sixth example of a source program including exception handling;

FIG. 11 is a diagram illustrating a third example of a configuration of a bytecode inspection unit according to at least one example embodiment;

FIG. 12 is a diagram illustrating a seventh example of a source program including exception handling;

FIG. 13 is a diagram illustrating an eighth example of a source program including exception handling;

FIG. 14 is a diagram illustrating a ninth example of a source program including exception handling;

FIG. 15 is a diagram illustrating a tenth example of a source program including exception handling;

FIG. 16 is a diagram illustrating a fourth example of a configuration of a bytecode inspection unit according to at least one example embodiment;

FIG. 17 is a diagram illustrating an eleventh example of a source program including exception handling;

FIG. 18 is a diagram illustrating a fifth example of a configuration of a bytecode inspection unit according to at least one example embodiment;

FIG. 19 is a diagram illustrating a twelfth example of a source program including exception handling;

FIG. 20 is a diagram illustrating a sixth example of a configuration of a bytecode inspection unit according to at least one example embodiment;

FIG. 21 is a diagram illustrating a seventh example of a configuration of a bytecode inspection unit according to at least one example embodiment;

FIG. 22 is a diagram illustrating an example of a procedure of a process in which the information processing device according to at least one example embodiment determines whether to perform preventive evaluation at a current position;

FIG. 23 is a diagram illustrating an example of a procedure of a process in which the bytecode inspection unit according to at least one example embodiment determines whether to perform preventive evaluation at a current position for preventing erroneous detection;

FIG. 24 is a diagram illustrating an example of a procedure of a process in which the bytecode inspection unit according to at least one example embodiment determines whether to perform preventive evaluation at a current position for preventing overlooking;

FIG. 25 is a diagram illustrating a thirteenth example of a source program including exception handling;

FIG. 26 is a diagram illustrating an example of assembly language-like display of a bytecode into which a source program is converted;

FIG. 27 is a diagram illustrating an example of a configuration of an information processing device according to at least one example embodiment;

FIG. 28 is a diagram illustrating an example of processing in an information processing method according to at least one example embodiment; and

FIG. 29 is a diagram illustrating an example of a configuration of a computer according to at least one example embodiment.

### EXAMPLE EMBODIMENT

Hereinafter, example embodiments will be described with reference to the drawings.

### First Example Embodiment

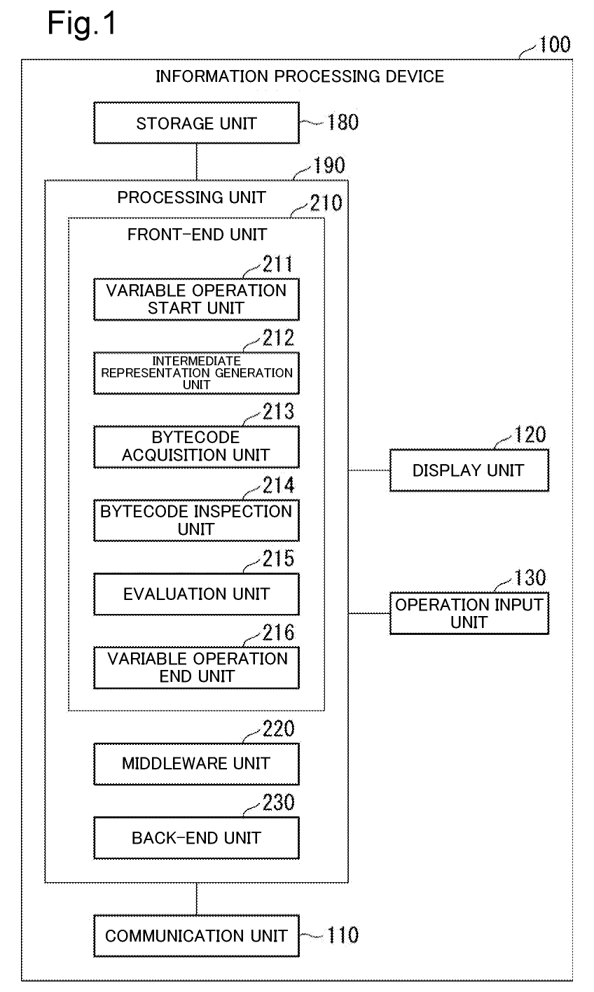

FIG. 1 is a diagram illustrating an example of a configuration of an information processing device according to at least one example embodiment. With the configuration illustrated in FIG. 1, an information processing device 100 includes a communication unit 110, a display unit 120, an operation input unit 130, a storage unit 180, and a processing unit 190. The processing unit 190 includes a front-end unit 210, a middleware unit 220, and a back-end unit 230. The front-end unit 210 includes a variable operation start unit 211, an intermediate representation generation unit 212, a bytecode acquisition unit 213, a bytecode inspection unit 214, an evaluation unit 215, and a variable operation end unit 216.

The information processing device 100 executes a source program by the lazy evaluation. In the lazy evaluation, the information processing device 100 partially converts the source program to intermediate representation (IR). Then, the information processing device 100 executes the intermediate representation to calculate the variable value at the time of execution of a command that requires a value of the variable, such as a “print” command. Obtaining a value of a variable is also referred to as evaluating the variable. For example, the information processing device 100 generates an intermediate representation by compilation at the time of execution of the source program, and performs the lazy evaluation on the generated intermediate representation.

The variable evaluated by the information processing device 100 is not limited to a specific type of variable. For example, the information processing device 100 may evaluate the data frame variable (variable in a matrix format), but is not limited thereto.

The source program here is a program to be executed by the information processing device 100. The source program may be a user program (a program created by a user), but is not limited thereto.

Converting the source program into the intermediate representation is also referred to as generating the intermediate representation.

The intermediate representation can be regarded as a program expressed in the form of an intermediate representation.

In execution of the source program by the lazy evaluation, the information processing device 100 adjusts the execution timing of the evaluation of the variable so that exception handling is performed similarly to the case of sequential execution.

Hereinafter, the exception is also referred to as an error, and the name (exception type) of the exception is also referred to as an error name.

Processing for an exception is also referred to as error handling.

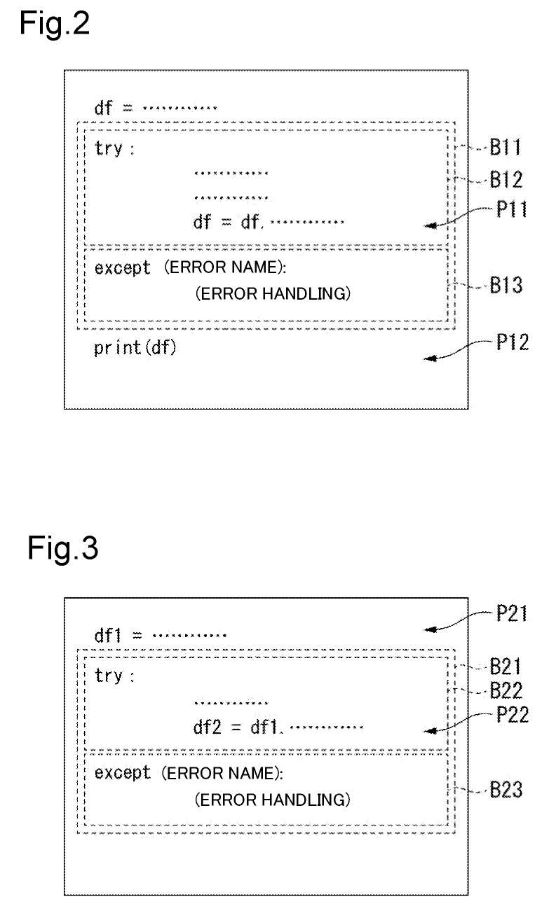

FIG. 2 is a diagram illustrating a first example of a source program including exception handling.

In the example of FIG. 2, “df” indicates a variable name, and “df

= ............” indicates that a value is substituted for the variable df. “df = df. ............” indicates that the value of the variable df is updated by substituting the value calculated with reference to the variable df into the variable df.

A portion B11 of the source program in FIG. 2 is relevant to an example of an exception handling block. The exception handling block indicates a target range of exception detection and processing to be performed in relation to exception detection. The portion B11 includes a portion B12 and a portion B13.

The portion B12 is a target range of exception detection in the exception handling block of the portion B11. The target range of exception detection in the exception handling block is also referred to as an exception detection target portion or a try block.

The portion B13 shows processing to be performed when an exception occurrence is detected in the portion B12. A portion indicating processing to be performed when an exception occurrence is detected is also referred to as an exception handling presentation portion or an except block.

A position P11 indicates the position of the assignment statement “df = df .............”. A position P12 indicates the position of the print statement “print(df)”.

Here, a case where the computer sequentially executes the source program of FIG. 2 will be considered.

In this case, at the position P11, the computer executes the assignment statement “df = df .............”. Specifically, the computer obtains the value of the variable df based on the right side of the assignment statement, and substitutes the obtained value for the variable df. Execution of the assignment statement “df = df .............” is relevant to an example of evaluating the variable df.

In the evaluation of the variable df at the position P11, in a case where an exception occurs for the error name shown in the portion B13, the computer performs the error handling shown in the portion B13.

Hereinafter, the occurrence of the exception of the error name indicated in the except block is also simply referred to as the occurrence of the exception.

On the other hand, in a case where the computer executes the source program of FIG. 2 by the lazy evaluation and does not adjust the evaluation timing, the computer generates an intermediate representation indicating the assignment statement “df = df .............” instead of executing the assignment statement “df = df .............” at the position P11.

Then, in execution of the print statement “print(df)” at the position P12, the computer obtains the value of the variable df by executing the intermediate representation generated at the position P11.

In this case, the computer evaluates, at the position P12, the variable df indicated at the position P11. Even if an exception occurs due to the evaluation of the variable df at the position P12, since it is outside the try block (the portion B12), the computer does not perform the error handling shown in the portion B13.

As described above, it is conceivable that the processing at the time of exception occurrence differs between the case of sequentially executing the example of FIG. 2 and the case of executing the example in the lazy evaluation. Performing evaluation of the variable indicated within the try block outside the try block (performing the evaluation after the exception handling block ends) is also referred to as overlooking.

On the other hand, in a case where it is determined that the overlooking may occur, the information processing device 100 prevents the occurrence of the overlooking by executing the operation at the appearance position of the operation for the variable. Here, the operation on the variable is to collectively execute the intermediate representations generated up to that time for the variable to obtain a specific processing result. An assignment statement for assigning a value to a variable is relevant to an example of an operation on the variable.

In the case of the example of FIG. 2, the information processing device 100 generates an intermediate representation indicating the assignment statement “df = df .............” at the position P11 and executes the generated intermediate representation. As a result, in a case where an exception occurs in execution of the assignment statement “df = df .............”, the information processing device 100 executes the error handling indicated in the portion B13.

The side in the progressing direction in execution of the source program is also referred to as a rear side, and the side opposite to the progressing direction is also referred to as a front side.

FIG. 3 is a diagram illustrating a second example of the source program including the exception handling.

In the example of FIG. 3, both “df1” and “df2” indicate variable names. “df1 = ............” indicates that a value is substituted for the variable df1. “df2 = df1 .............” indicates that a value calculated with reference to the variable df1 is substituted into the variable df2.

A portion B21 of the source program in FIG. 3 is relevant to an example of an exception handling block. The portion B21 includes a portion B22 and a portion B23.

The portion B22 is a try block in the exception handling block of the portion B21.

The portion B23 is an except block in the exception handling block of the portion B21.

The portion B23 shows processing to be performed when an exception is detected in the portion B22.

A position P21 indicates the position of the assignment statement “df1 = ............”. A position P22 indicates the position of the assignment statement “df2 = df1 .............”.

Here, a case where the computer sequentially executes the source program of FIG. 3 will be considered.

In this case, at the position P21, the computer executes the assignment statement “df1 = ............”.

Execution of the assignment statement “df1 = ............” is relevant to an example of evaluating the variable df1.

In a case where an exception occurs in the evaluation of the variable df1 at the position P21, the computer will not perform the error handling shown in the portion B23 since it is outside the try block (the portion B22).

On the other hand, in a case where the computer executes the source program of FIG. 3 by the lazy evaluation and does not adjust the evaluation timing, the computer generates an intermediate representation indicating execution of the assignment statement “df1 = ............” instead of execution of the assignment statement “df1 = ............” at the position P21.

Then, in execution of the substitution “df2 = df1 .............” at the position P22, the computer executes the intermediate representation generated at the position P21 to obtain the value of the variable df1 and obtain the value of the variable df2. Obtaining the value of the variable df1 in execution of the substitution “df2 = df1 .............” is relevant to an example of evaluating the variable df1.

In this case, the computer evaluates, at the position P22, the variable df1 indicated at the position P21. In a case where an exception due to the evaluation of the variable df1 occurs at the position P22, since it is in the try block (the portion B22), the computer executes the error handling illustrated in the portion B23.

As described above, it is conceivable that the processing at the time of exception occurrence differs between the case of sequentially executing the example of FIG. 3 and the case of executing the example in the lazy evaluation. Performing, within the try block, evaluation of a variable indicated outside the try block (before the try block) is also referred to as erroneous detection.

On the other hand, in a case where it is determined that erroneous detection may occur, the information processing device 100 prevents the occurrence of erroneous detection by executing the operation at the appearance position of the operation on the variable.

In the case of the example of FIG. 3, the information processing device 100 generates an intermediate representation indicating the assignment statement “df1 = ............” at the position P21 and executes the generated intermediate representation. As a result, in a case where an exception occurs in execution of the assignment statement “df1 = ............”, the information processing device 100 does not execute the error handling indicated in the portion B23.

Evaluation of variables performed to prevent overlooking and evaluation of variables performed to prevent erroneous detection are also referred to as preventive evaluation.

In the configuration of FIG. 1, the communication unit 110 communicates with another device. For example, the communication unit 110 may receive the source program from another device. The communication unit 110 may transmit the execution result of the source program to another device such as a terminal device of the user, for example.

For example, the display unit 120 includes a display screen such as a light emitting diode (LED) panel or a liquid crystal panel, and displays various images. For example, the display unit 120 may display the execution result of the source program.

The operation input unit 130 includes an input device such as a keyboard and a mouse, and receives a user operation. For example, the operation input unit 130 may receive a user operation for designating a source program to be executed, a user operation for designating an option of execution of the source program, and a user operation for instructing execution of the source program.

The storage unit 180 stores various data. For example, the storage unit 180 may store the intermediate representation generated by the information processing device 100 in the lazy evaluation of the source program. The storage unit 180 is configured using a storage device included in the information processing device 100.

The processing unit 190 controls each unit of the information processing device 100 to perform various types of processing. The function of the processing unit 190 is implemented when a central processing unit (CPU) included in the information processing device 100 reads a program from the storage unit 180 and executes the program.

The front-end unit 210 partially converts the source program into an intermediate representation. Specifically, the front-end unit 210 traces the source program according to the execution order indicated in the source program, and generates an intermediate representation for the lazy evaluation. Hereinafter, the position on the source program that the front-end unit 210 refers to by tracing the source program (alternatively, a code obtained by converting the source program) is also referred to as a current position.

The front-end unit 210 determines whether to evaluate a variable appearing at the current position as an operated variable, and evaluates the determined variable to be evaluated. Determining whether to evaluate the variable appearing at the current position can be regarded as detecting, from the current position, the evaluation target variable at the current position. Detecting the variable from the current position as used herein means detecting the variable from the code (description of the program) at the current position.

Hereinafter, a case where the front-end unit 210 refers to the bytecode converted from the source program instead of referring to the source program will be described as an example. However, the front-end unit 210 may directly refer to the source program.

The variable operation start unit 211 functions as an interface from the source program side to the intermediate representation side.

For example, the variable operation start unit 211 acquires, from the source program, information regarding the current position of the source program such as acquiring information regarding a variable operated at the current position.

Then, the variable operation start unit 211 issues an instruction to the subsequent functional unit. For example, the variable operation start unit 211 instructs the intermediate representation generation unit 212 to generate the intermediate representation following the variable operated with the current value. In this manner, the variable operated at the current position is a target of intermediate representation generation. The variable operation start unit 211 instructs the bytecode acquisition unit 213 to acquire the bytecode with reference to the current position where the variable to be operated appears.

The intermediate representation generation unit 212 generates an intermediate representation. Specifically, the intermediate representation generation unit 212 uses the generated intermediate representation to generate an intermediate representation for obtaining the value of the variable to be operated at the current position.

The bytecode acquisition unit 213 acquires the bytecode of the source program.

The bytecode inspection unit 214 refers to the bytecode of the source program to determine whether to evaluate the variable appearing as a variable to be operated at the current position (current position of execution of the source program). Determining whether to evaluate the variable appearing at the current position by the bytecode inspection unit 214 can be regarded as detecting the evaluation target variable at the current position from the current position.

The bytecode inspection unit 214 is relevant to an example of a variable detection means.

The evaluation unit 215 evaluates a variable. In particular, the evaluation unit 215 evaluates the variable determined to be evaluated by the bytecode inspection unit 214. The evaluation unit 215 evaluates a variable appearing in a command that requires evaluation, such as a “print” statement.

The evaluation unit 215 is relevant to an example of an evaluation means.

The variable operation end unit 216 functions as an interface from the intermediate representation side to the source program side.

For example, the variable operation end unit 216 wraps the intermediate representation as a variable on the intermediate representation side or the data of the specific processing result obtained by evaluating the intermediate representation in the form of the variable of the user program and returns the data to the source program side.

The middleware unit 220 optimizes the intermediate representation generated by the intermediate representation generation unit 212.

The optimization performed by the middleware unit 220 is not limited to a specific optimization. For example, the middleware unit 220 may perform optimization to advance the execution order of the process of deleting the column of the data frame variable (variable indicated in matrix format), but is not limited thereto.

The back-end unit 230 executes the intermediate representation.

The function of the back-end unit 230 may be executed using hardware different from the hardware that executes the function of the front-end unit 210.

For example, the information processing device 100 may include an accelerator such as a graphics processing unit (GPU) in addition to a CPU, and the function of the processing unit 190 may be executed using the accelerator in addition to the CPU. Then, the function of the front-end unit 210 may be executed using the CPU, and the function of the back-end unit 230 may be executed using the accelerator such as a GPU.

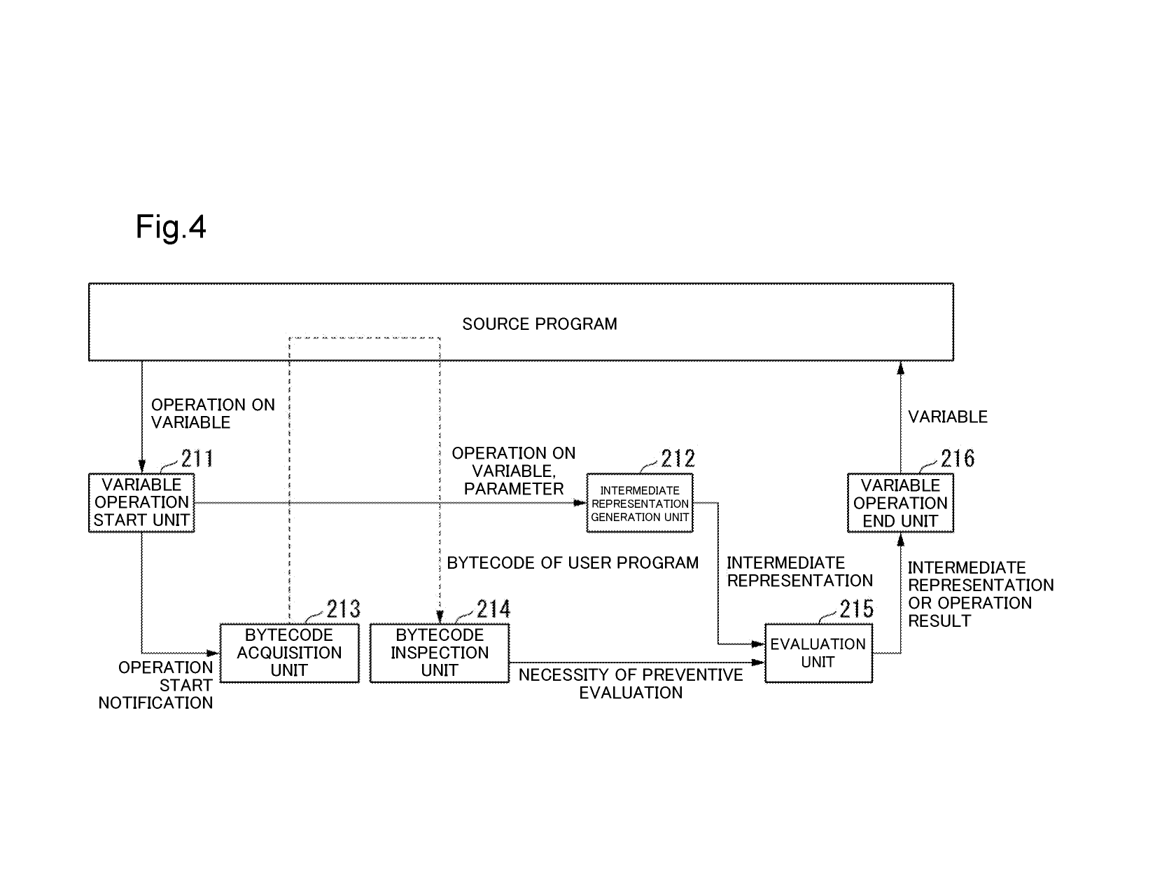

FIG. 4 is a diagram illustrating an example of data input and output in each unit of the front-end unit 210.

In the example of FIG. 4, the variable operation start unit 211 acquires, from the source program, information regarding the current position of the source program such as acquiring information regarding a variable operated at the current position. Then, the variable operation start unit 211 outputs an instruction to generate an intermediate representation following the variable operated with the current value and information indicating the parameter in the operation to the intermediate representation generation unit 212. The variable operation start unit 211 instructs the bytecode acquisition unit 213 to acquire the bytecode with reference to the current position where the variable to be operated appears.

The intermediate representation generation unit 212 generates an intermediate representation indicating a command at the current position of program execution based on the information indicating the operation on the variable and the parameter in the operation output from the variable operation start unit 211.

The bytecode acquisition unit 213 acquires a bytecode to be referred to for determining whether to perform preventive evaluation at the current position. The bytecode acquisition unit 213 outputs the acquired bytecode to the bytecode inspection unit 214.

The bytecode inspection unit 214 determines whether to evaluate a variable appearing at the current position as an operated variable with reference to the bytecode. In particular, the bytecode inspection unit 214 determines whether to perform preventive evaluation on the variable appearing at the current position. In a case where the bytecode inspection unit 214 determines that the command to be evaluated such as the print statement is at the current position, it may be determined to evaluate the variable indicated in the command.

The bytecode inspection unit 214 outputs information indicating necessity of evaluation for the variable to the evaluation unit 215.

In a case where the bytecode inspection unit 214 determines to evaluate a variable, the evaluation unit 215 evaluates the variable. Specifically, the evaluation unit 215 calculates the variable value by executing the intermediate representation output from the intermediate representation generation unit 212.

When evaluating the variable, the evaluation unit 215 outputs the variable value of the evaluation result to the variable operation end unit 216. On the other hand, in a case where the variable has not been evaluated, the evaluation unit 215 outputs the intermediate representation output from the intermediate representation generation unit 212 to the variable operation end unit 216.

The variable operation end unit 216 wraps the variable value (the data of the specific processing result obtained by evaluating the intermediate representation) or the intermediate representation output from the evaluation unit 215 in the form of the variable of the source program and returns the variable value or the intermediate representation to the source program side.

### First example

The bytecode inspection unit 214 may determine to perform preventive evaluation on all variables to be operated in the try block and all variables to be operated before the exception handling block (before the try block).

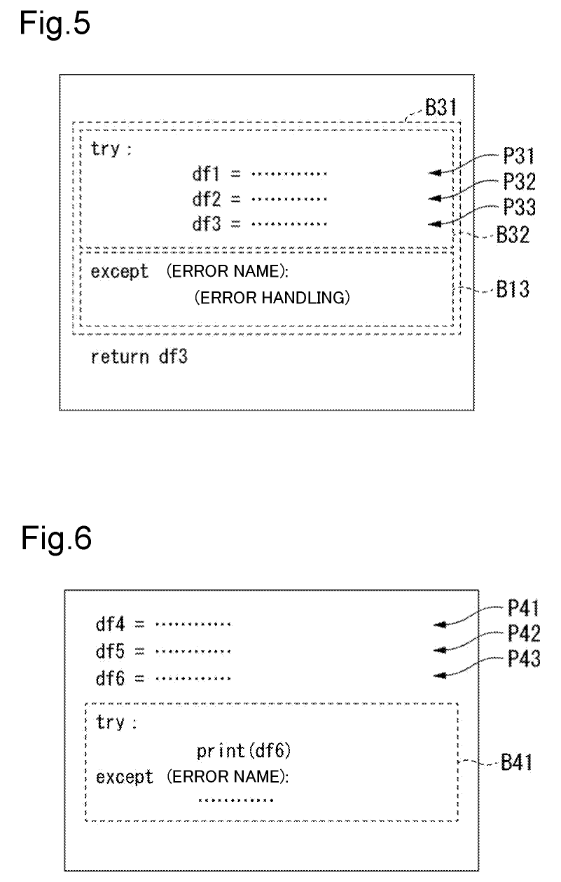

FIG. 5 is a diagram illustrating a third example of the source program including the exception handling.

In the example of FIG. 5, “df1”, “df2”, and “df3” all indicate variable names. “df1 = ............” indicates that a value is substituted for the variable df1. “df2 = ............” indicates that a value is substituted for the variable df2. “df3 = ............” indicates that a value is substituted for the variable df3.

The assignment statement “df1 = ............” is relevant to an example of an operation on the variable df1. Execution of the assignment statement “df1 = ............” is relevant to an example of evaluating the variable df1. The assignment statement “df2 = ............” is relevant to an example of an operation on the variable df2. Execution of the assignment statement “df2 = ............” is relevant to an example of evaluating the variable df2. The assignment statement “df3 = ............” is relevant to an example of an operation on the variable df3. Execution of the assignment statement “df3 = ............” is relevant to an example of evaluating the variable df3.

A portion B31 of the source program in FIG. 5 is relevant to an example of an exception handling block. The portion B31 includes a portion B32 and a portion B33.

The portion B32 is a try block in the exception handling block of the portion B31.

The portion B33 is an except block in the exception handling block of the portion B31.

The portion B33 shows the processing to be performed when an exception occurrence is detected in the portion B32.

A position P31 indicates the position of the assignment statement “df1 = ............”. A position P32 indicates the position of the assignment statement “df2 = ............”. A position P33 indicates the position of the assignment statement “df3 = ............”.

In the first example, in order to prevent overlooking, the bytecode inspection unit 214 determines all variables operated in the exception handling block as evaluation targets.

In the example of FIG. 5, when the current position is the position P31, the bytecode inspection unit 214 determines to evaluate the variable df1. At the position P31, the evaluation of the variable df1 is performed by executing the assignment statement “df1 = ............”.

When the current position is the position P32, the bytecode inspection unit 214 determines to evaluate the variable df2. At the position P32, the evaluation of the variable df2 is performed by executing an assignment statement “df2 = ............”.

When the current position is the position P33, the bytecode inspection unit 214 determines to evaluate the variable df3. At the position P33, the evaluation of the variable df3 is performed by executing an assignment statement “df3 = ............”.

The evaluation unit 215 evaluates the variable determined to be evaluated by the bytecode inspection unit 214, thereby preventing overlooking.

FIG. 6 is a diagram illustrating a fourth example of the source program including the exception handling.

In the example of FIG. 6, “df4”, “df5”, and “df6” all indicate variable names. “df4 = ............” indicates that a value is substituted for the variable df4. “df5 = ............” indicates that a value is substituted for the variable df5. “df6 = ............” indicates that a value is substituted for the variable df6.

The assignment statement “df4 = ............” is relevant to an example of an operation on the variable df4. Execution of the assignment statement “df4 = ............” is relevant to an example of evaluating the variable df4. The assignment statement “df5 = ............” is relevant to an example of an operation on the variable df5. Execution of the assignment statement “df5 = ............” is relevant to an example of evaluating the variable df5. The assignment statement “df6 = ............” is relevant to an example of an operation on the variable df6. Execution of the assignment statement “df6 = ............” is relevant to an example of evaluating the variable df6.

A portion B41 of the source program in FIG. 6 is relevant to an example of an exception handling block. The exception handling block of the portion B41 includes a try block and an except block.

A position P41 indicates the position of the assignment statement “df4 = ............”. A position P42 indicates the position of the assignment statement “df5 = ............”. A position P43 indicates the position of the assignment statement “df6 = ............”.

In the first example, in order to prevent erroneous detection, the bytecode inspection unit 214 determines all variables operated before the exception handling block (on the opposite side of the progressing direction of program execution) as evaluation targets.

In the example of FIG. 6, when the current position is the position P41, the bytecode inspection unit 214 determines to evaluate the variable df4. At the position P41, the evaluation of the variable df4 is performed by executing an assignment statement “df4 = ............”.

When the current position is the position P42, the bytecode inspection unit 214 determines to evaluate the variable df5. At the position P42, the evaluation of the variable df5 is performed by executing an assignment statement “df5 = ............”.

When the current position is the position P43, the bytecode inspection unit 214 determines to evaluate the variable df6. At the position P43, the evaluation of the variable df6 is performed by executing an assignment statement “df6 = ............”.

The evaluation unit 215 evaluates the variable determined to be evaluated by the bytecode inspection unit 214, thereby preventing erroneous detection.

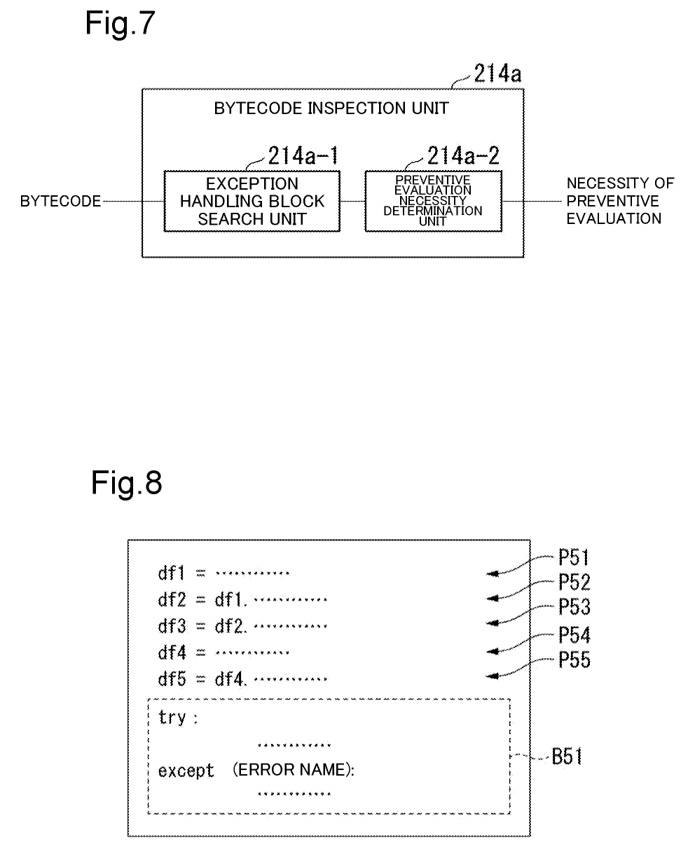

FIG. 7 is a diagram illustrating a first example of the configuration of the bytecode inspection unit 214. In the configuration of FIG. 7, a bytecode inspection unit 214a includes an exception handling block search unit 214a-1 and a preventive evaluation necessity determination unit 214a-2.

The bytecode inspection unit 214a is relevant to an example of the bytecode inspection unit 214.

The exception handling block search unit 214a-1 searches for an exception handling block with reference to the bytecode converted from the source program. When detecting the exception handling block, the exception handling block search unit 214a-1 detects a positional relationship between the exception handling block and the current position.

The preventive evaluation necessity determination unit 214a-2 determines whether a condition that the entire exception handling block or a part of the exception detection target portion (try block) of the exception handling block is present on the side in the progressing direction of program execution with respect to the current position is satisfied based on the search result by the exception handling block search unit 214a-1. The presence of a part of the exception detection target portion on the side in the progressing direction of program execution with respect to the current position means that the current position is located within the try block.

In a case where it is determined that such a condition is satisfied, the preventive evaluation necessity determination unit 214a-2 determines to perform evaluation on the variable appearing at the current position as the variable to be operated. In a case where a plurality of variables appears at the current position as variables to be operated, the preventive evaluation necessity determination unit 214a-2 determines to perform evaluation on all variables appearing at the current position as variables to be operated.

The processing performed by the bytecode inspection unit 214a is relevant to an example of a process of detecting, from the current position, an evaluation target variable at the current position in a case where it is determined that the entire exception handling block is present on the side in the progressing direction of program execution with respect to the current position or the current position is within the try block.

It can be said that the processing performed by the bytecode inspection unit 214a prevents overlooking or erroneous detection by evaluating all variables operated at the current position in a case where it is determined that there is a possibility of overlooking or erroneous detection. This can be seen as a naive way to prevent overlooking or erroneous detection.

### Second example

In order to prevent overlooking in the first example described above, the bytecode inspection unit 214 may exclude a variable that has a chance of being evaluated after the current position (on the side in the progressing direction of program execution) and before the end of the try block from the evaluation target at the current position.

In order to prevent erroneous detection in the first example described above, the bytecode inspection unit 214 may exclude a variable that has a chance of being evaluated after the current position (on the side in the progressing direction of program execution) and before the head of the exception handling block (on the opposite side in the progressing direction of program execution) from the evaluation target at the current position, in the first example described above.

FIG. 8 is a diagram illustrating a fifth example of the source program including the exception handling. FIG. 8 illustrates an example of a scene in which determination of preventive evaluation for preventing erroneous detection is performed.

In the example of FIG. 8, “df1”, “df2”, “df3”, “df4”, and “df5” all indicate variable names.

“df1 = ............” indicates that a value is substituted for the variable df1. “df2 = df1 .............” indicates that a value calculated with reference to the variable df1 is substituted into the variable df2. “df3 = df2 .............” indicates that a value calculated with reference to the variable df2 is substituted into the variable df3. “df4 = ............” indicates that a value is substituted for the variable df4. “df5 = df4 .............” indicates that a value calculated with reference to the variable df4 is substituted into the variable df5.

The assignment statement “df1 = ............” is relevant to an example of an operation on the variable df1. Execution of the assignment statement “df1 = ............” is relevant to an example of evaluating the variable df1.

The assignment statement “df2 = df1 ............” is relevant to an example of an operation on the variable df2. Execution of the assignment statement “df2 = df1 .............” is relevant to an example of evaluating the variable df2. Obtaining the value of the variable df1 in execution of the assignment statement “df2 = df1 .............” is relevant to an example of evaluating the variable df1.

The assignment statement “df3 = df2 ............” is relevant to an example of an operation on the variable df3. Execution of the assignment statement “df3 = df2 .............” is relevant to an example of evaluating the variable df3. Obtaining the value of the variable df2 in execution of the assignment statement “df3 = df2 .............” is relevant to an example of evaluating the variable df2.

The assignment statement “df4 = ............” is relevant to an example of an operation on the variable df4. Execution of the assignment statement “df4 = ............” is relevant to an example of evaluating the variable df4.

The assignment statement “df5 = df4 ............” is relevant to an example of an operation on the variable df5. Execution of the assignment statement “df5 = df4 .............” is relevant to an example of evaluating the variable df5. Obtaining the value of the variable df4 in execution of the assignment statement “df5 = df4 .............” is relevant to an example of evaluating the variable df4.

A portion B51 of the source program in FIG. 8 is relevant to an example of an exception handling block. The exception handling block of the portion B51 includes a try block and an except block.

A position P51 indicates the position of the assignment statement “df1 = ............”. A position P52 indicates the position of the assignment statement “df2 = df1 .............”. A position P53 indicates the position of the assignment statement “df3 = df2 .............”. A position P54 indicates the position of the assignment statement “df4 = ............”. A position P55 indicates the position of the assignment statement “df5 = df4 .............”.

In the example of FIG. 8, the value of the variable df2 is required to obtain the value of the variable df3, and the value of the variable df1 is required to obtain the value of the variable df2. In order to obtain the value of the variable df5, the value of the variable df4 is required.

The bytecode inspection unit 214 analyzes such variable value dependency (reference relationship of variable values) for a range after the current position and before the exception handling block (in the example of FIG. 8, the portion B51). Then, in a case where there is a chance that the variable appearing at the current position as a variable to be operated is evaluated within a range after the current position and before the exception handling block, the bytecode inspection unit 214 determines that the variable is not a target of evaluation at the current position. That is, the variable is excluded from the evaluation target at the current position.

Information representing the dependence relationship of the variable value by a variable name sequence is also referred to as a variable operation sequence. In the example of FIG. 8, the dependence relationship of the variable values can be expressed by two variable operation sequences of the variable operation sequence df1-df2-df3 and the variable operation sequence d4-df5.

In the case of the example of FIG. 8, at the position P51, the bytecode inspection unit 214 determines that the variable df1 is not to be evaluated at the current position. At the position P52, the bytecode inspection unit 214 determines that the variable df2 and the variable df1 are not to be evaluated at the current position.

On the other hand, in the range after the position P53 and before the portion B51, there is no chance to evaluate the variable df3. Therefore, at the position P53, the bytecode inspection unit 214 determines to evaluate the variable df3.

In accordance with this determination, the evaluation unit 215 evaluates the variable df3 at the position P53. At the position P53, the evaluation unit 215 evaluates the variable df2 for evaluating the variable df3 and evaluates the variable df1 for evaluating the variable df2. As a result, it is possible to prevent erroneous detection of the variables df1, df2, and df3.

For example, in a case where the second example is implemented in combination with the first example, determining a variable that has a chance of being evaluated in a range after the current position and before the exception handling block as a variable not to be evaluated at the current position (that is, in a case where the second example is implemented with respect to the first example) can be regarded as detecting the variable as an evaluation target variable at the current position in a case where it is determined that the entire exception handling block is present on the side in the progressing direction of program execution with respect to the current position, and the variable appearing at the current position as the variable to be operated does not appear on the side of the starting position of the exception handling block on the side in the progressing direction of program execution with respect to the current position.

In the case of preventing overlooking, the bytecode inspection unit 214 analyzes the dependence relationship of the variable value for the range after the current position and up to the end of the try block. Then, in a case where there is a chance that the variable appearing at the current position as a variable to be operated is evaluated within a range after the current position and up to the end of the try block, the bytecode inspection unit 214 determines that the variable is not to be evaluated at the current position.

For example, in a case where the second example is implemented in combination with the first example, determining a variable that has a chance of being evaluated within the range after the current position and up to the end of the try block as a variable not to be evaluated at the current position can be regarded as detecting the variable as an evaluation target variable in a case where it is determined that the current position is located within the try block and the variable appearing at the current position as the variable to be operated does not appear up to the end position of the exception detection target portion on the side in the progressing direction of program execution with respect to the current position.

As a result, the information processing device 100 can prevent overlooking.

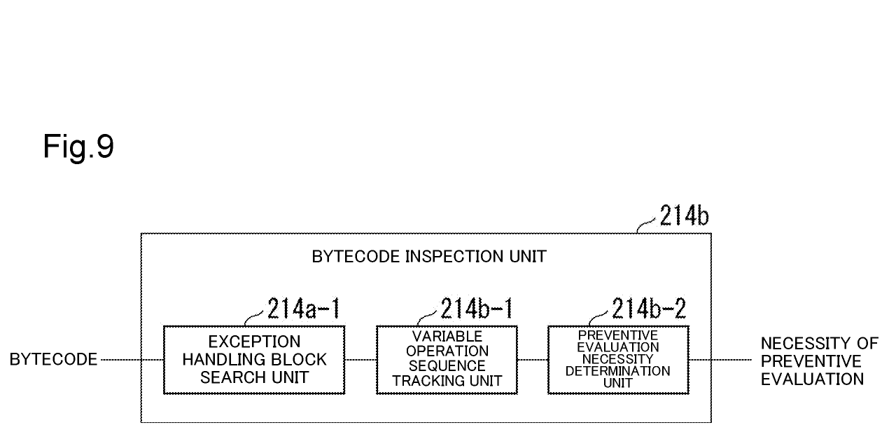

FIG. 9 is a diagram illustrating a second example of the configuration of the bytecode inspection unit 214. In the configuration of FIG. 9, a bytecode inspection unit 214b includes an exception handling block search unit 214a-1, a variable operation sequence tracking unit 214b-1, and a preventive evaluation necessity determination unit 214b-2.

The bytecode inspection unit 214b is relevant to an example of the bytecode inspection unit 214.

Of the parts in FIG. 9, parts having similar functions associated with the parts in FIG. 7 are denoted by the same reference numerals (214a-1), and a detailed description thereof will be omitted here.

In a case where the exception handling block search unit 214a-1 detects the exception handling block, the variable operation sequence tracking unit 214b-1 analyzes the dependency relation of the variable value.

When it is determined that the current position is located before the exception handling block (that is, in a case where it is determined that there is a possibility of erroneous detection), the variable operation sequence tracking unit 214b-1 determines whether there is a chance that the variable appearing at the current position as the variable to be operated is evaluated after the current position and before the start position of the exception handling block.

In a case where it is determined that the current position is located within the try block (that is, in a case where it is determined that there is a possibility of overlooking), the variable operation sequence tracking unit 214b-1 determines whether there is a chance that the variable appearing at the current position as the variable to be operated is evaluated after the current position and up to the end of the try block.

The preventive evaluation necessity determination unit 214b-2 determines whether to perform the preventive evaluation on the variable appearing at the current position at the current position based on the search result by the exception handling block search unit 214a-1 and the analysis result by the variable operation sequence tracking unit 214b-1.

For example, in a case where the second example is implemented in combination with the first example, the preventive evaluation necessity determination unit 214b-2 determines whether to perform the preventive evaluation at the current position as follows.

In a case where the exception handling block is detected after the current position, and it is determined that there is no chance that the variable appearing at the current position as the variable to be operated is evaluated after the current position and before the start position of the exception handling block, the preventive evaluation necessity determination unit 214b-2 determines to perform the preventive evaluation on the variable at the current position.

In a case where it is determined that the current position is located within the try block and it is determined that there is no chance that the variable appearing at the current position as the variable to be operated is evaluated after the current position and before the end of the try block, the preventive evaluation necessity determination unit 214b-2 determines to perform the preventive evaluation on the variable at the current position.

On the other hand, in a case where it is determined that the exception handling block is not detected after the current position and the current position is not located within the try block, the preventive evaluation necessity determination unit 214b-2 determines not to perform the preventive evaluation at the current position on the variable appearing at the current position as the variable to be operated.

Even in a case where it is determined that the current position is located before the exception handling block and it is determined that there is a chance that the variable appearing at the current position as the variable to be operated is evaluated after the current position and before the start position of the exception handling block, the preventive evaluation necessity determination unit 214b-2 determines not to perform the preventive evaluation on the variable at the current position.

Also in a case where it is determined that the current position is located within the try block and it is determined that there is a chance that the variable appearing at the current position as the variable to be operated is evaluated after the current position and before the end of the try block, the preventive evaluation necessity determination unit 214b-2 determines not to perform the preventive evaluation on the variable at the current position.

The processing performed by the bytecode inspection unit 214b is relevant to an example of a process of detecting, from the current position, an evaluation target variable at the current position in a case where it is determined that the entire exception handling block is present on the side in the progressing direction of program execution with respect to the current position or the current position is located within the try block.

In the processing performed by the bytecode inspection unit 214b, in a case where it is determined that the variable appearing at the current position as the variable to be operated appears after the current position and before the end of the try block in a scene where overlooking may occur, and in a case where it is determined that the variable appearing at the current position as the variable to be operated appears after the current position and before the start position of the exception handling block in a scene where erroneous detection may occur, it can be grasped that the variable is not to be evaluated at the current position. The scene where overlooking may occur here is a case where the current position is located within the try block. The scene where erroneous detection may occur here is a case where the entire exception handling block is present after the current position.

Since the variable appearing at the current position is not evaluated at the current position, the evaluation of the variable can be delayed. Delaying the evaluation of the variable increases the possibility that optimization can be performed on the intermediate representation.

In a case where a conditional statement or a loop is present after the current position and in the try block in a scene where overlooking may occur, and in a case where a conditional statement or a loop is present after the current position and before the start position of the exception handling block in a scene where erroneous detection may occur, it is expected that the necessity of the preventive evaluation can be determined with higher accuracy by performing processing as in the fourth example described later. The accuracy of the determination as to whether the preventive evaluation is necessary can be evaluated by the same degree to which exception handling is performed (how much exception handling is similarly performed) in a case where the program is executed by the lazy evaluation and in a case where the program is executed sequentially.

### Third example

In order to prevent erroneous detection in the first example described above or to prevent erroneous detection in the second example described above, the bytecode inspection unit 214 may exclude variables that are not used in the exception handling block from being evaluated at the current position.

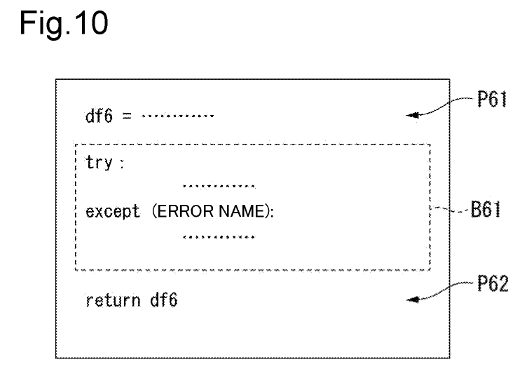

FIG. 10 is a diagram illustrating a sixth example of the source program including the exception handling. FIG. 10 illustrates an example of a scene in which determination of preventive evaluation for preventing erroneous detection is performed.

In the example of FIG. 10, “df6” indicates a variable name. “df6 = ............” indicates that a value is substituted for the variable df6.

Execution of the assignment statement “df6 = ............” is relevant to an example of evaluating the variable df6.

A portion B61 of the source program in FIG. 10 is relevant to an example of an exception handling block.

The exception handling block of the portion B61 includes a try block and an except block. In the example of FIG. 10, it is assumed that the variable df6 does not appear within the exception handling block of the portion B61.

A position P61 indicates the position of the assignment statement “df6 = ............”. A position P62 indicates the position of the return statement “return df6”. The return statement “return df6” indicates that the function including the program portion illustrated in FIG. 10 is ended and the value of the variable df6 is returned as a return value. In the return statement “return df6”, the variable df6 is evaluated.

In the example of FIG. 10, since the variable df6 does not appear within the exception handling block, even if the variable df6 is not evaluated at the position P61, erroneous detection does not occur.

It is also conceivable that the variable df6 is not located within the exception handling block, but is used to calculate the value of another variable such as an assignment statement “df7 = df6. ...............”, and another variable (for example, the variable df7) appears within the exception handling block. In this case, since the variable df6 is also evaluated at the time of evaluating other variables, even if the variable df6 is not evaluated at the position P61, erroneous detection does not occur.

As described above, in a case where the variable appearing at the current position as the variable to be operated does not appear within the exception handling block after the current position, the bytecode inspection unit 214 excludes the variable from the target of the preventive evaluation at the current position.

Since the variable appearing at the current position is not evaluated at the current position, the evaluation of the variable can be delayed. Delaying the evaluation of the variable increases the possibility that optimization can be performed on the intermediate representation.

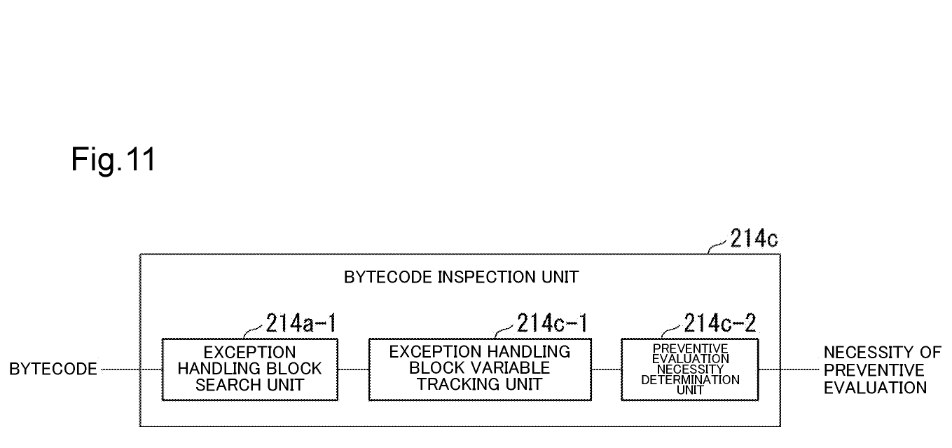

FIG. 11 is a diagram illustrating a third example of the configuration of the bytecode inspection unit 214. In the configuration of FIG. 11, a bytecode inspection unit 214c includes an exception handling block search unit 214a-1, an in-exception-handling-block-variable tracking unit 214c-1, and a preventive evaluation necessity determination unit 214c-2.

The bytecode inspection unit 214c is relevant to an example of the bytecode inspection unit 214.

Of the parts in FIG. 11, parts having similar functions associated with the parts in FIG. 7 are denoted by the same reference numerals (214a-1), and a detailed description thereof will be omitted here.

In a case where the exception handling block search unit 214a-1 detects the entire exception handling block after the current position, the in-exception-handling-block-variable tracking unit 214c-1 determines whether the variable appearing at the current position as a variable to be operated appears within the exception handling block.

The preventive evaluation necessity determination unit 214c-2 determines whether to perform the preventive evaluation on the variable appearing at the current position at the current position based on the search result by the exception handling block search unit 214a-1 and the determination result by the in-exception-handling-block-variable tracking unit 214c-1.

For example, in a case where the third example is implemented in combination with the first example, the preventive evaluation necessity determination unit 214c-2 determines whether to perform the preventive evaluation at the current position as follows.

In a case where the entire exception handling block is detected after the current position, and it is determined that the variable appearing at the current position as the variable to be operated appears within the exception handling block, the preventive evaluation necessity determination unit 214c-2 determines to perform the preventive evaluation on the variable at the current position.

In a case where it is determined that the current position is located within the try block, the preventive evaluation necessity determination unit 214c-2 determines to perform the preventive evaluation at the current position on the variable appearing at the current position as the variable to be operated.

On the other hand, in a case where it is determined that the exception handling block is not detected after the current position and the current position is not located within the try block, the preventive evaluation necessity determination unit 214c-2 determines not to perform the preventive evaluation at the current position on the variable appearing at the current position as the variable to be operated.

Even in a case where the exception handling block is detected after the current position, and it is determined that the variable appearing at the current position as the variable to be operated does not appear within the exception handling block, the preventive evaluation necessity determination unit 214c-2 determines not to perform the preventive evaluation on the variable at the current position.

The processing performed by the bytecode inspection unit 214c is relevant to an example of a process of detecting an evaluation target variable at the current position from the current position in a case where it is determined that the entire exception handling block or a part of the exception detection target portion of the exception handling block is present on the side in the progressing direction of program execution with respect to the current position.

As described above, in a case where the bytecode inspection unit 214c determines that the entire exception handling block is present on the side in the progressing direction of program execution with respect to the current position and the variable appearing at the current position as the variable to be operated does not appear within the exception handling block, the bytecode inspection unit excludes the variable from the target of the preventive evaluation at the current position.

Since the variable appearing at the current position is not evaluated at the current position, the evaluation of the variable can be delayed. Delaying the evaluation of the variable increases the possibility that optimization can be performed on the intermediate representation.

### Fourth example

In a case where the variable appearing at the current position as the variable to be operated appears in the conditional statement or in the loop, when the bytecode inspection unit 214 determines whether to perform the preventive evaluation at the current position, the inside of the conditional statement or the inside of the loop may be excluded from the target of consideration so as to be determined on the safe side so that overlooking or erroneous detection does not occur.

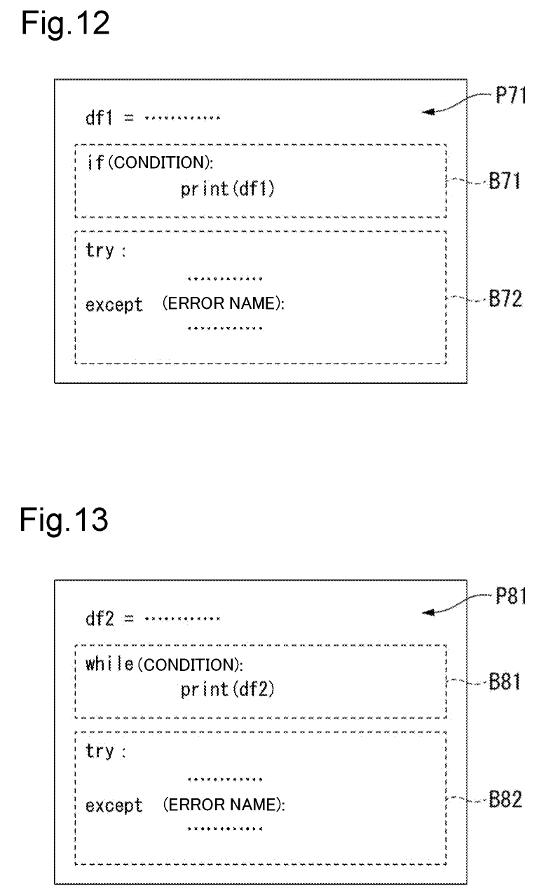

FIG. 12 is a diagram illustrating a seventh example of the source program including the exception handling. FIG. 12 illustrates an example of a scene in which determination of preventive evaluation for preventing erroneous detection is performed.

In the example of FIG. 12, “df1” indicates a variable name. “df1 = ............” indicates that a value is substituted for the variable df1. “print(df1)” indicates that the value of the variable df1 is output, such as displaying the value of the variable df1.

The assignment statement “df1 = ............” is relevant to an example of an operation on the variable df1. Execution of the assignment statement “df1 = ............” and execution of the print command “print(df1)” both are relevant to examples of evaluating the variable df1.

A portion B71 of the source program in FIG. 12 is relevant to an example of a conditional statement.

A portion B72 is relevant to an example of an exception handling block. The exception handling block of the portion B72 includes a try block and an except block.

A position P71 indicates the position of the assignment statement “df1 = ............”. The print command “print(df1)” is located in the conditional statement of the portion B71.

The portion B71 is located after the position P71, and the portion B72 is located after the portion B71.

Here, a case where the current position is the position P71 and the bytecode inspection unit 214 determines whether to perform the preventive evaluation on the variable df1 appearing at the position P71 will be considered.

In this case, if the print command “print(df1)” in the conditional statement of the portion B71 is executed, it is conceivable that, according to the second example, the bytecode inspection unit 214 determines not to perform the preventive evaluation on the variable df1 at the position P71.

However, when the current position is the position P71, it is unclear whether the print command “print(df1)” in the conditional statement for the portion B71 is executed. The variable df2 does not appear outside the conditional statement of the portion B71 within the range after the position P71 and before the exception handling block of the portion B72.

Therefore, the bytecode inspection unit 214 determines to perform the preventive evaluation on the variable df1 at the position P71. Specifically, the bytecode inspection unit 214 determines to execute the assignment statement “df1 = ............” at the position P71.

As a result, even when the print command “print(df1)” in the conditional statement of the portion B71 is not executed, it is possible to prevent erroneous detection due to lazy evaluation of the variable df1 appearing in the portion B71.

FIG. 13 is a diagram illustrating an eighth example of the source program including the exception handling. FIG. 13 illustrates an example of a scene in which determination of preventive evaluation for preventing erroneous detection is performed.

In the example of FIG. 13, “df2” indicates a variable name. “df2 = ............” indicates that a value is substituted for the variable df2. “print(df2)” indicates that the value of the variable df2 is output, such as displaying the value of the variable df2.

The assignment statement “df2 = ............” is relevant to an example of an operation on the variable df2. Execution of the assignment statement “df2 = ............” and execution of the print command “print(df2)” both are relevant to examples of evaluating the variable df2.

A portion B81 of the source program in FIG. 13 is relevant to an example of a loop.

A portion B82 is relevant to an example of an exception handling block. The exception handling block of the portion B82 includes a try block and an except block.

A position P81 indicates the position of the assignment statement “df2 = ............”. The print command “print(df1)” is located in the conditional statement of the portion B71.

The portion B81 is located after the position P81, and the portion B82 is located after the portion B81.

Here, a case where the current position is the position P81 and the bytecode inspection unit 214 determines whether to perform the preventive evaluation on the variable df2 appearing at the position P81 will be considered.

In this case, if the print command “print(df2)” in the conditional statement of the portion B81 is executed, it is conceivable that, according to the second example, the bytecode inspection unit 214 determines not to perform the preventive evaluation on the variable df2 at the position P81.

However, when the current position is the position P81, it is unknown whether the print command “print(df2)” in the loop of the portion B81 is executed. In particular, there is a possibility that the number of repetitive executions of the loop becomes 0. The variable df2 does not appear outside the loop of the portion B81 within the range after the position P81 and before the exception handling block of the portion B82.

Therefore, the bytecode inspection unit 214 determines to perform the preventive evaluation on the variable df2 at the position P81. Specifically, the bytecode inspection unit 214 determines to execute the assignment statement “df1 = ............” at the position P81.

As a result, even when the print command “print(df2)” in the loop of the portion B81 is not executed, it is possible to prevent erroneous detection due to lazy evaluation of the variable df2 appearing in the portion B81.

As described above, in a case where the conditional statement or the loop is present after the current position, the exception handling block is present after the conditional statement or the loop, and the variable appearing at the current position as the variable to be operated does not appear outside the conditional statement or the loop within the range after the current position and before the exception handling block, determining to perform the preventive evaluation at the current position on the variable appearing at the current position as the variable to be operated can be regarded as detecting the variable as the evaluation target variable at the current position.

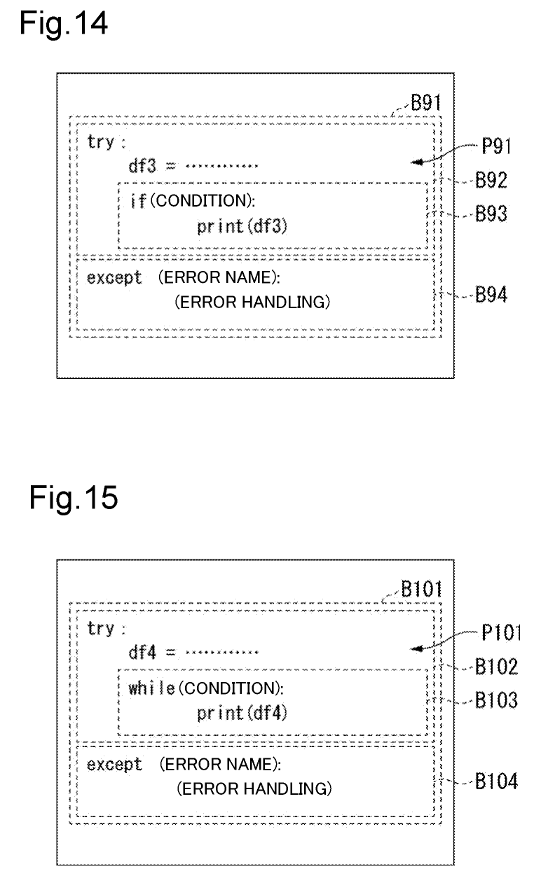

FIG. 14 is a diagram illustrating a ninth example of the source program including the exception handling. FIG. 14 illustrates an example of a scene in which determination of preventive evaluation for prevention of overlooking is performed.

In the example of FIG. 14, “df3” indicates a variable name. “df3 = ............” indicates that a value is substituted for the variable df3. “print(df3)” indicates that the value of the variable df3 is output, such as displaying the value of the variable df3.

The assignment statement “df3 = ............” is relevant to an example of an operation on the variable df3. Execution of the assignment statement “df3 = ............” and execution of the print command “print(df3)” both are relevant to examples of evaluating the variable df3.

A portion B91 of the source program in FIG. 14 is relevant to an example of an exception handling block.

The portion B91 includes a portion B92 and a portion B94.

The portion B92 is a try block in the exception handling block of the portion B91.

The portion B94 is an except block in the exception handling block of the portion B91.

The portion B94 shows the processing to be performed when an exception occurrence is detected in the portion B92.

The portion B92 includes a position P91 and a portion B93. The position P91 indicates the position of the assignment statement “df3 = ............”. The portion B93 is relevant to an example of a conditional statement. The portion B93 includes a print command “print(df3)”.

In the portion B92, the portion B93 is located after the position P91.

Here, a case where the current position is the position P91 and the bytecode inspection unit 214 determines whether to perform the preventive evaluation on the variable df3 appearing at the position P91 will be considered.

In this case, if the print command “print(df3)” in the conditional statement of the portion B93 is executed, it is conceivable that, according to the second example, the bytecode inspection unit 214 determines not to perform the preventive evaluation on the variable df3 at the position P91.

However, when the current position is the position P91, it is unclear whether the print command “print(df3)” in the conditional statement for the portion B93 is executed. After the position P91 and within the try block of the portion B92, the variable df3 does not appear outside the conditional statement of the portion B93.

Therefore, the bytecode inspection unit 214 determines to perform the preventive evaluation on the variable df3 at the position P91. Specifically, the bytecode inspection unit 214 determines to execute the assignment statement “df3 = ............” at the position P91.

As a result, even when the print command “print(df3)” in the conditional statement of the portion B93 is not executed, it is possible to prevent overlooking due to lazy evaluation of the variable df3 appearing in the portion B91.

FIG. 15 is a diagram illustrating a tenth example of the source program including the exception handling. FIG. 15 illustrates an example of a scene in which determination of preventive evaluation for prevention of overlooking is performed.

In the example of FIG. 15, “df4” indicates a variable name. “df4 = ............” indicates that a value is substituted for the variable df4. “print(df4)” indicates that the value of the variable df4 is output, such as displaying the value of the variable df4.

The assignment statement “df4 = ............” is relevant to an example of an operation on the variable df4. Execution of the assignment statement “df4 = ............” and execution of the print command “print(df4)” both are relevant to examples of evaluating the variable df4.

A portion B101 of the source program in FIG. 15 is relevant to an example of an exception handling block. The portion B101 includes a portion B102 and a portion B104.

The portion B102 is a try block in the exception handling block of the portion B101.

The portion B104 is an except block in the exception handling block of the portion B101. The portion B104 shows the processing to be performed when an exception occurrence is detected in the portion B102.

The portion B102 includes a position P101 and a portion B103.

The position P101 indicates the position of the assignment statement “df4 = ............”.

The portion B103 is relevant to an example of a loop.

The portion B103 includes a print command “print(df4)”.

In the portion B102, the portion B103 is located after the position P101.

Here, a case where the current position is the position P101 and the bytecode inspection unit 214 determines whether to perform the preventive evaluation on the variable df4 appearing at the position P101 will be considered.

In this case, if the print command “print(df4)” in the conditional statement of the portion B103 is executed, it is conceivable that, according to the second example, the bytecode inspection unit 214 determines not to perform the preventive evaluation on the variable df4 at the position P101.

However, when the current position is the position P101, it is unknown whether the print command “print(df4)” in the loop of the portion B103 is executed. The variable df4 does not appear outside the loop of the portion B103 after the position P101 and within the try block of the portion B102.

Therefore, the bytecode inspection unit 214 determines to perform the preventive evaluation on the variable df4 at the position P101. Specifically, the bytecode inspection unit 214 determines to execute the assignment statement “df4 = ............” at the position P101.

As a result, even when the print command “print(df4)” in the loop of the portion B103 is not executed, it is possible to prevent overlooking due to lazy evaluation of the variable df4 appearing in the portion B101.

As described above, in a case where the current position is within the try block, the conditional statement or the loop is present after the current position and within the try block, and the variable appearing at the current position does not appear after the current position and outside the conditional statement or the loop within the try block, determining to perform the preventive evaluation at the current position on the variable appearing at the current position can be regarded as detecting the variable as the evaluation target variable at the current position.

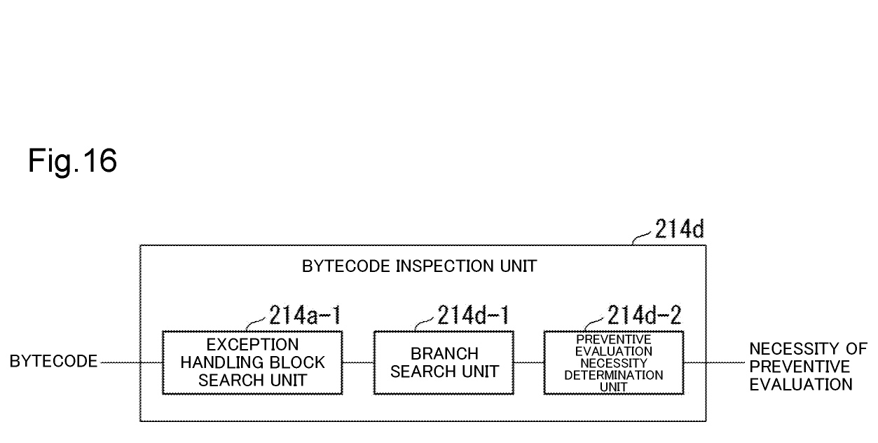

FIG. 16 is a diagram illustrating a fourth example of the configuration of the bytecode inspection unit 214. In the configuration of FIG. 16, a bytecode inspection unit 214d includes an exception handling block search unit 214a-1, a branch search unit 214d-1, and a preventive evaluation necessity determination unit 214d-2.

The bytecode inspection unit 214d is relevant to an example of the bytecode inspection unit 214.

Of the parts in FIG. 16, parts having similar functions associated with the parts in FIG. 7 are denoted by the same reference numerals (214a-1), and a detailed description thereof will be omitted here.

In a case where the exception handling block search unit 214a-1 detects the exception handling block after the current position, the branch search unit 214d-1 determines whether a conditional statement or a loop is present after the current position and before the exception handling block.

In a case where the exception handling block search unit 214a-1 determines that the current position is located within the try block, the branch search unit 214d-1 determines whether a conditional statement or a loop is present after the current position and within the try block.

The preventive evaluation necessity determination unit 214d-2 determines whether to perform, at the current position, the preventive evaluation on the variable appearing at the current position based on the search result by the exception handling block search unit 214a-1 and the search result by the branch search unit 214d-1.

For example, in a case where the fourth example is implemented in combination with the first example and the second example, the preventive evaluation necessity determination unit 214d-2 determines whether to perform the preventive evaluation at the current position as follows.

In a case where it is determined that the exception handling block is detected after the current position, the conditional statement or the loop is detected after the current position and before the exception handling block, and the variable appearing at the current position as the variable to be operated does not appear outside the conditional statement or the loop after the current position and before the exception handling block, the preventive evaluation necessity determination unit 214d-2 determines to perform the preventive evaluation at the current position on the variable appearing at the current position.

In a case where it is determined that the exception handling block is detected after the current position, the conditional statement or the loop is detected after the current position and before the exception handling block, and the variable appearing at the current position as the variable to be operated appears outside the conditional statement or the loop after the current position and before the exception handling block, the preventive evaluation necessity determination unit 214d-2 determines not to perform the preventive evaluation at the current position on the variable appearing at the current position.

In a case where the exception handling block is detected after the current position and the conditional statement or the loop is not detected after the current position and before the exception handling block, the preventive evaluation necessity determination unit 214d-2 determines whether to perform, at the current position, the preventive evaluation on the variable appearing at the current position similarly to the preventive evaluation necessity determination unit 214b-2 of the second example.

In a case where it is determined that the current position is located within the try block, the conditional statement or the loop is detected after the current position and within the try block, and the variable appearing at the current position as the variable to be operated does not appear outside the conditional statement or the loop after the current position and within the try block, the preventive evaluation necessity determination unit 214d-2 determines to perform the preventive evaluation at the current position.

In a case where it is determined that the exception handling block is detected after the current position, the conditional statement or the loop is detected after the current position and within the try block, and the variable appearing at the current position as the variable to be operated appears outside the conditional statement or the loop after the current position and within the try block, the preventive evaluation necessity determination unit 214d-2 determines not to perform the preventive evaluation at the current position.

In a case where it is determined that the current position is located within the try block, and no conditional statement or loop is detected after the current position and within the try block, the preventive evaluation necessity determination unit 214d-2 determines whether to perform the preventive evaluation at the current position on the variable appearing at the current position similarly to the preventive evaluation necessity determination unit 214b-2 of the second example.

The processing performed by the bytecode inspection unit 214d is relevant to an example of a process of detecting an evaluation target variable at the current position from the current position in a case where it is determined that the entire exception handling block or a part of the exception detection target portion of the exception handling block is present on the side in the progressing direction of program execution with respect to the current position.

As described above, in a case where it is determined that the entire exception handling block is present on the side in the progressing direction of program execution with respect to the current position, the conditional statement or the loop is located on the side in the progressing direction of program execution with respect to the current position and on the current position side with respect to the start position of the exception handling block, and the variable appearing at the current position as the variable to be operated appears on the current position side with respect to the start position of the exception handling block and outside the conditional statement or the loop on the side in the progressing direction of program execution with respect to the current position, the bytecode inspection unit 214d determines that the variable is outside the target for evaluation at the current position.

In a case where it is determined that the current position is located within the exception detection target portion of the exception handling block, a conditional statement or a loop is present up to the exception detection target portion on the side in the progressing direction of program execution with respect to the current position, and the variable appearing at the current position as the variable to be operated appears up to the end position of the exception detection target portion on the side in the progressing direction of program execution with respect to the current position and outside the conditional statement or the loop, the bytecode inspection unit 214d determines that the variable is not to be evaluated at the current position.

Since the variable appearing at the current position is not evaluated at the current position, the evaluation of the variable can be delayed. Delaying the evaluation of the variable increases the possibility that optimization can be performed on the intermediate representation.

### Fifth example

In a case where the current position is located in the function, the bytecode inspection unit 214 may determine the presence or absence of the exception handling block or the presence or absence of a part of the try block even after the caller of the function. The presence of a part of the try block after the caller of the function can be regarded as the fact that the caller of the function is located within the try block.

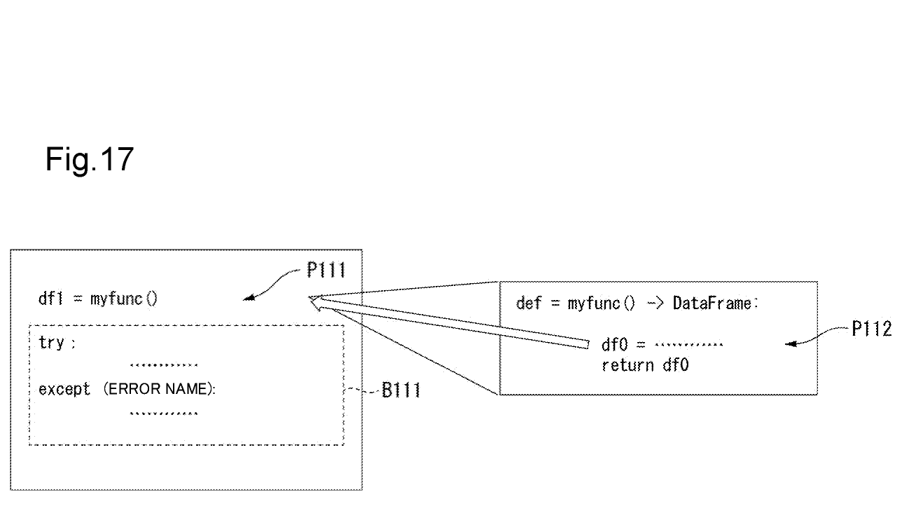

FIG. 17 is a diagram illustrating an eleventh example of the source program including the exception handling. FIG. 17 illustrates an example of a scene in which determination of preventive evaluation for preventing erroneous detection is performed.

In the example of FIG. 17, “df0” indicates a variable name. “df0 = ............” indicates that a value is substituted for the variable df0. A position P112 indicates the position of the assignment statement “df0 = ............”.

The position P112 is located within the function “myfunc”. The function “myfunc” is called by “df1 = myfunc” at a position P111. “return df0” in the function “myfunc” is a return statement indicating that the function “myfunc” returns the value of the variable df0 as a return value.

A portion B111 is relevant to an example of an exception handling block. The portion B111 is located after the position P111.

Here, a case where the current position is the position P112 and the bytecode inspection unit 214 determines whether to perform the preventive evaluation on the variable df0 appearing at the position P112 will be considered.

In this case, the bytecode inspection unit 214 determines the presence or absence of the exception handling block and the presence or absence of a part of the try block after the position P112 and within the function “myfunc”. Furthermore, the bytecode inspection unit 214 determines the presence or absence of the exception handling block and the presence or absence of a part of the try block after the position P111 that is the caller of the function “myfunc”. At that time, the bytecode inspection unit 214 detects the position of the caller of the function “myfunc” by tracing back the stack frame.

For example, in a case where the fifth example is implemented in combination with the first example, the bytecode inspection unit 214 determines whether to perform the preventive evaluation at the current position as follows.

In any of a case where it is determined that the entire exception handling block is present after the position P112 (current position) and within the function “myfunc”, a case where it is determined that the position P112 is located within the try block, a case where it is determined that the entire exception handling block is present after the position P111 (function caller), and a case where it is determined that the position P111 is located within the try block, the bytecode inspection unit 214 determines to perform preventive evaluation at the current position.

In the example of FIG. 17, an exception handling block (the portion B111) is present after the position P111 (caller of the function), and the bytecode inspection unit 214 determines to perform preventive evaluation at the current position (the position P112).

On the other hand, in a case where it is determined that there is no entire exception handling block after the current position and within the function, the current position is not located within the try block, the entire exception handling block is not present after the caller of the function, and the caller of the function is not located within the try block, the bytecode inspection unit 214 determines not to perform preventive evaluation at the current position.

The bytecode inspection unit 214 may determine whether the value of the variable appearing at the current position as the variable to be operated is referred to when obtaining the return value, and may determine the presence or absence of the exception handling block and the presence or absence of a part of the try block after the caller of the function only in a case where it is determined that the value is referred.

In the case of the example of FIG. 17, the bytecode inspection unit 214 detects that the variable df0 appearing at the current position is a return value of the function “myfunc”, and determines that the value of the variable df0 appearing at the current position is referred to when obtaining the return value. Then, the bytecode inspection unit 214 determines the presence or absence of the exception handling block and the presence or absence of a part of the try block after the position P111 that is the caller of the function “myfunc”.

Alternatively, in all the cases where the current position is located within the function, the bytecode inspection unit 214 may determine the presence or absence of the exception handling block and the presence or absence of a part of the try block after the caller of the function. In this case, it can be understood that the bytecode inspection unit 214 determines whether to perform the preventive evaluation at the current position on the safety side so that overlooking or erroneous detection does not occur.

In a case where the function calls are nested, the bytecode inspection unit 214 may detect the caller of the function and repeatedly perform a process of determining the presence or absence of the exception handling block and the presence or absence of a part of the try block after the caller of the function.

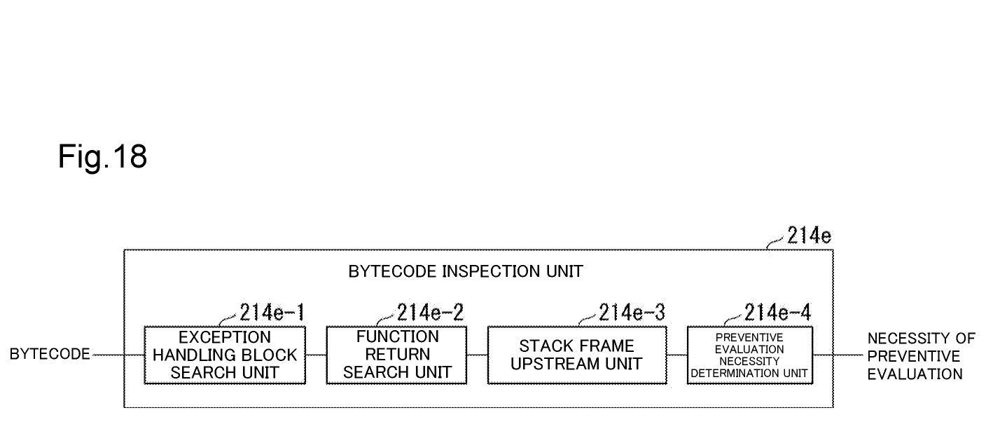

FIG. 18 is a diagram illustrating a fifth example of the configuration of the bytecode inspection unit 214. In the configuration of FIG. 18, a bytecode inspection unit 214e includes an exception handling block search unit 214e-1, a function return search unit 214e-2, a stack frame upstream unit 214e-3, and a preventive evaluation necessity determination unit 214e-4.

The exception handling block search unit 214e-1 determines whether the entire exception handling block is present after the current position and whether the current position is located within the try block. In particular, in a case where the current position is located within the function, the exception handling block search unit 214e-1 also handles the caller of the function as the current position. Specifically, the exception handling block search unit 214e-1 determines whether the entire exception handling block is present after the caller of the function, and whether the caller of the function is located within the try block.

The function return search unit 214e-2 determines whether the current position is within the function by determining whether a return statement is present after the current position. Furthermore, the function return search unit 214e-2 may determine whether the value of the variable appearing at the current position as the variable to be operated is referred to when obtaining the return value.

The stack frame upstream unit 214e-3 detects the caller of the function by tracing back the stack frame.

The preventive evaluation necessity determination unit 214e-4 determines whether to perform the preventive evaluation at the current position based on the determination result of the exception handling block search unit 214e-1.

For example, in a case where the fifth example is implemented in combination with the first example, the preventive evaluation necessity determination unit 214e-4 determines whether to perform the preventive evaluation at the current position as follows.

In both a case where it is determined that an exception handling block or a part of a try block is present after the current position and within the function, and a case where it is determined that an exception handling block or a part of a try block is present after the caller of the function, the preventive evaluation necessity determination unit 214e-4 determines to perform the preventive evaluation at the current position.

On the other hand, in a case where it is determined that there is neither an exception handling block nor a part of the try block after the current position and within the function, and there is neither an exception handling block nor a part of the try block after the caller of the function, the preventive evaluation necessity determination unit 214e-4 determines not to perform the preventive evaluation at the current position.

The processing performed by the bytecode inspection unit 214e is relevant to an example of a process of detecting an evaluation target variable at the current position from the current position in a case where it is determined that the entire exception handling block or a part of the exception detection target portion of the exception handling block is present on the side in the progressing direction of program execution with respect to the current position.

As described above, in a case where the current position is located within the function, the bytecode inspection unit 214e determines whether to detect the variable appearing at the current position as the variable to be operated as the evaluation target variable at the current position based on the side in the progressing direction of the program with respect to the caller of the function in addition to the side in the progressing direction of the program with respect to the current position in the function.

In this regard, the bytecode inspection unit 214e can determine the necessity of the preventive evaluation with high accuracy even in a case where the current position is located within the function.

In a case where the function calls are nested, the bytecode inspection unit 214e may follow the caller of the function from the function having the current position to the uppermost function, and determine whether to perform the preventive evaluation at the current position. That is, the bytecode inspection unit 214e may determine whether to detect, as the evaluation target variable at the current position, a variable appearing at the current position as the variable to be operated based on the side in the progressing direction of the program with respect to each caller after tracing the caller of the function from the function at the current position to the uppermost function.

### Sixth example

In a case where the function is called after the current position, the bytecode inspection unit 214 may determine whether to perform the preventive evaluation at the current position according to the called function. Therefore, a whitelist indicating a function that does not require preventive evaluation may be prepared in advance.

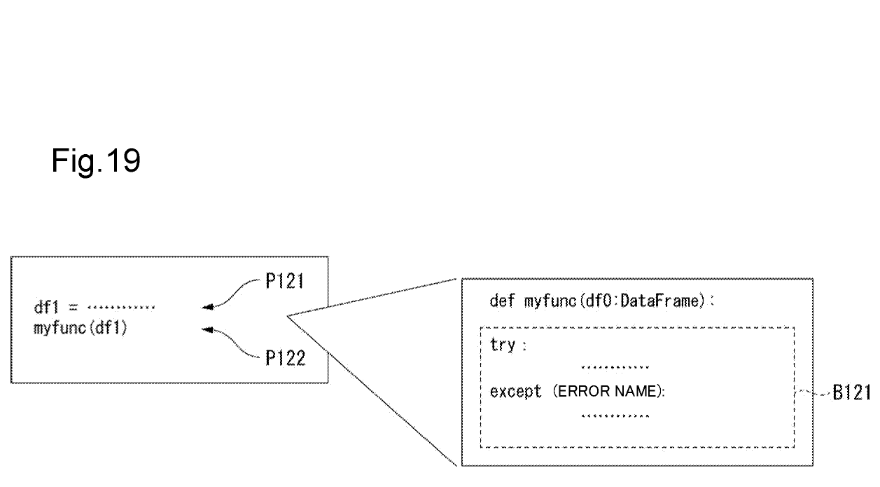

FIG. 19 is a diagram illustrating a twelfth example of the source program including the exception handling. FIG. 19 illustrates an example of a scene in which determination of preventive evaluation for preventing erroneous detection is performed.

In the example of FIG. 19, “df1” indicates a variable name. “df1 = ............” indicates that a value is substituted for the variable df1. A position P121 indicates the position of the assignment statement “df1 = ............”. “myfunc(df1)” indicates that the function “myfunc” is called by passing the variable df1 as an argument. The position P122 indicates the position of the function call “myfunc(df1)”.

A portion B121 is relevant to an example of an exception handling block. The portion B121 lies within the function “myfunc”.

Here, a case where the current position is the position P121 and the bytecode inspection unit 214 determines whether to perform the preventive evaluation on the variable df1 appearing at the position P121 will be considered. It is assumed that there is no exception handling block other than the function “myfunc” after the position P121 which is the current position.

In this case, the bytecode inspection unit 214 determines whether the function “myfunc” is on the whitelist. In the whitelist, a function name not including an exception handling block is described.

In a case where there is a function that is called after the current position and is not on the whitelist, the bytecode inspection unit 214 determines to perform preventive evaluation at the current position.

In the example of FIG. 19, the function “myfunc” includes an exception handling block and is not on the whitelist. Therefore, the bytecode inspection unit 214 determines to perform the preventive evaluation at the position P121 which is the current position.

On the other hand, in a case where all the functions called after the current position are on the whitelist and there is no exception handling block other than the functions after the current position, the bytecode inspection unit 214 determines not to perform the preventive evaluation at the current position. In this case, it can be said that it has been detected that there is no exception handling block after the current position.

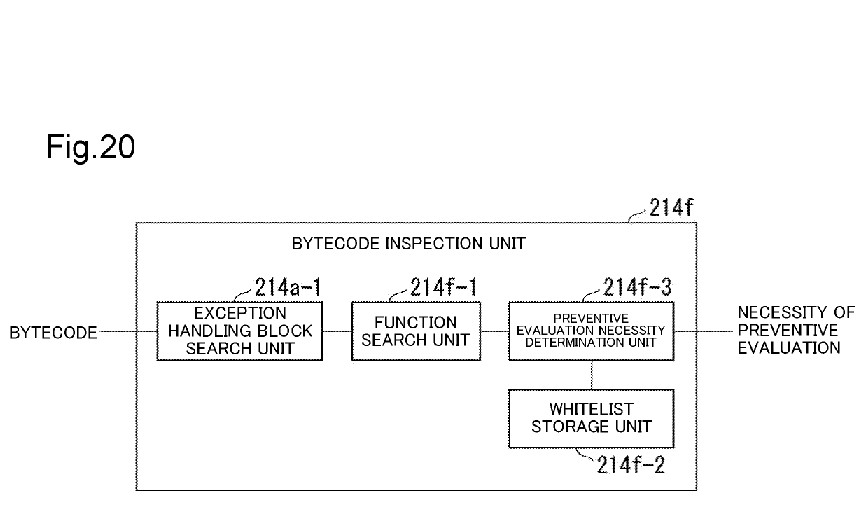

FIG. 20 is a diagram illustrating a sixth example of the configuration of the bytecode inspection unit 214. In the configuration of FIG. 20, a bytecode inspection unit 214f includes an exception handling block search unit 214a-1, a function search unit 214f-1, a whitelist storage unit 214f-2, and a preventive evaluation necessity determination unit 214f-3.

The bytecode inspection unit 214f is relevant to an example of the bytecode inspection unit 214.

The same reference numeral (214a-1) is assigned to a portion having a similar function relevant to each portion in FIG. 7 among the units in FIG. 20. In the example of FIG. 20, the exception handling block search unit 214a-1 determines whether the current position is located within the try block, and determines whether an exception handling block is present after the current position for a function other than the called function.

The function search unit 214f-1 searches for a function called later than the current position. When detecting the function, the function search unit 214f-1 outputs the function name of the detected function to the preventive evaluation necessity determination unit 214f-3.

The whitelist storage unit 214f-2 stores in advance a whitelist indicating a function not including an exception handling block. Here, “in advance” may be before the information processing device 100 starts executing the source program.

The storage unit 180 may include the whitelist storage unit 214f-2.

The preventive evaluation necessity determination unit 214f-3 determines whether to perform the preventive evaluation at the current position based on the search result by the exception handling block search unit 214a-1 and the search result by the function search unit 214f-1.

In any of a case where the exception handling block search unit 214a-1 determines that the current position is located within the try block, a case where the exception handling block search unit 214a-1 detects an exception handling block after the current position, and a case where the function search unit 214f-1 detects a function not registered in the whitelist, the preventive evaluation necessity determination unit 214f-3 determines to perform the preventive evaluation at the current position.

In the example of FIG. 19, the function search unit 214f-1 detects the function “myfunc”. Then, the detected function “myfunc” is not on the whitelist stored in the whitelist storage unit 214f-2. Therefore, the preventive evaluation necessity determination unit 214f-3 determines to perform the preventive evaluation at the current position.

On the other hand, in a case where the exception handling block search unit 214a-1 determines that the current position is not located within the try block and there is no exception handling block after the current position, and the function search unit 214f-1 has not detected a function that is not registered in the whitelist, the preventive evaluation necessity determination unit 214f-3 determines not to perform the preventive evaluation at the current position.

The processing performed by the bytecode inspection unit 214f is relevant to an example of a process of detecting an evaluation target variable at the current position from the current position in a case where it is determined that the entire exception handling block or a part of the exception detection target portion of the exception handling block is present on the side in the progressing direction of program execution with respect to the current position.

In the processing performed by the bytecode inspection unit 214d, it can be said that the process of determining the possibility of overlooking and the possibility of erroneous detection and determining whether to perform the preventive evaluation at the current position is performed using the whitelist for a function called after the current position.

All or some of the first to sixth examples described above may be implemented in combination.

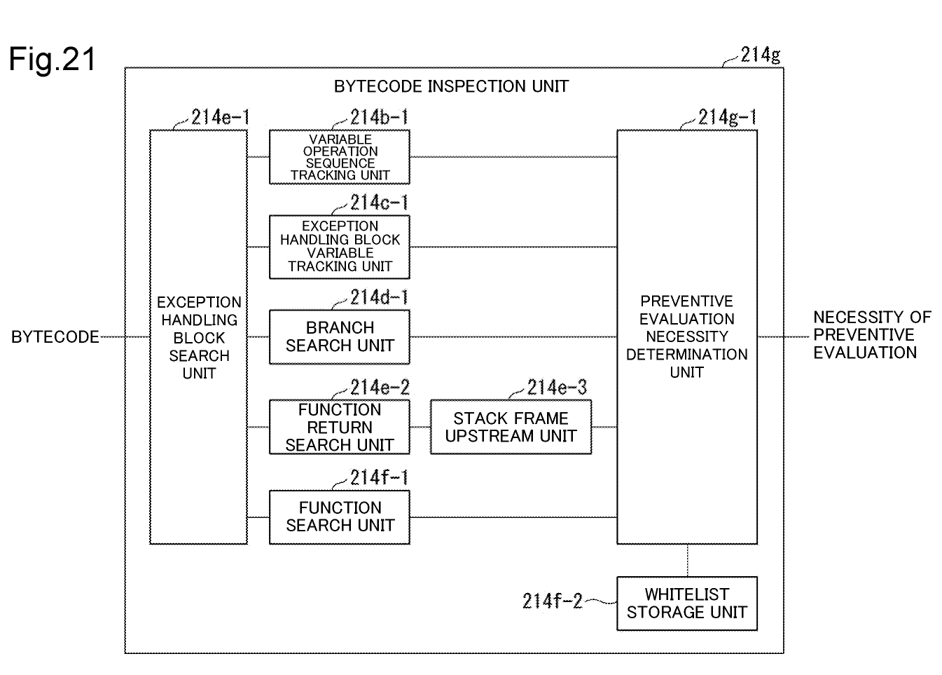

FIG. 21 is a diagram illustrating a seventh example of the configuration of the bytecode inspection unit 214. In the configuration of FIG. 21, the bytecode inspection unit 214g includes an exception handling block search unit 214e-1, a variable operation sequence tracking unit 214b-1, an in-exception-handling-block-variable tracking unit 214c-1, a branch search unit 214d-1, a function return search unit 214e-2, a stack frame upstream unit 214e-3, a function search unit 214f-1, a whitelist storage unit 214f-2, and a preventive evaluation necessity determination unit 214g-1.

Of the parts in FIG. 21, parts having similar functions to those of the parts in FIG. 7, FIG. 9, FIG. 11, FIG. 16, FIG. 18, or FIG. 20 are denoted by the same reference numerals (214b-1, 214c-1, 214d-1, 214e-1, 214e-2, 214e-3, 214f-1, 214f-2), and a detailed description thereof is omitted here.

In FIG. 21, the exception handling block search unit 214e-1 determines whether the current position is located within the try block, and determines whether an exception handling block is present after the current position for a function other than the function to be called, similarly to the description of the exception handling block search unit 214a-1 in FIG. 20. As described with reference to FIG. 18, the exception handling block search unit 214e-1 goes back to the caller of the function, and determines whether the current position is located within the try block and determines whether an exception handling block is present after the current position. In other words, in FIG. 21, the exception handling block search unit 214e-1 goes back to the caller of the function, determines whether the current position is located within the try block, and determines whether an exception handling block is present after the current position for a function other than the called function.

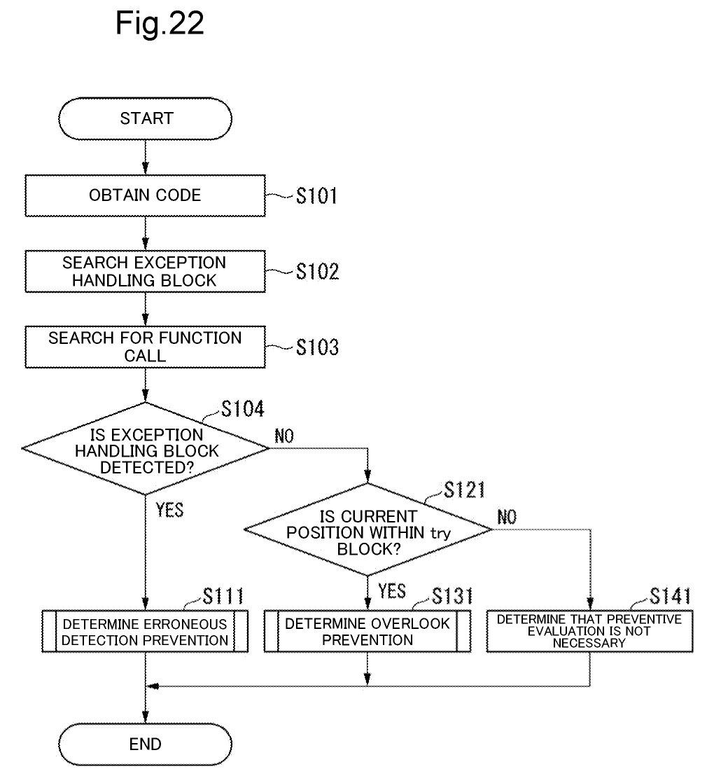

The preventive evaluation necessity determination unit 214g-1 determines whether to perform the preventive evaluation at the current position based on the search result by the exception handling block search unit 214e-1, the search result by the variable operation sequence tracking unit 214b-1, the search result by the in-exception-handling-block-variable tracking unit 214c-1, the search result by the branch search unit 214d-1, and the search result by the function search unit 214f-1. As illustrated in FIG. 22, the preventive evaluation necessity determination unit 214g-1 performs a comprehensive process of the processes performed by the preventive evaluation necessity determination units 214a-2, 214b-2, 214c-2, 214d-2, 214e-4, and 214f-3, and determines whether to perform the preventive evaluation at the current position.

FIG. 22 is a diagram illustrating an example of a procedure of a process in which the information processing device 100 determines whether to perform the preventive evaluation at the current position. The processing of FIG. 22 will be described below with an example in which the bytecode inspection unit 214 has the configuration of the bytecode inspection unit 214g of FIG. 21.

(Step S101)

The bytecode acquisition unit 213 acquires the bytecode converted

from the source program. The information processing device 100 analyzes the source program by analyzing the bytecode.

After step S101, the process proceeds to step S102.

(Step S102)

The exception handling block search unit 214a-1 searches for an exception handling block after the current position.

In a case where the current position is located within the function, the exception handling block search unit 214a-1 treats a position after the caller of the function as a position after the current position, and searches for an exception handling block. This is relevant to the processing in the fifth example described above. In a case where the fifth example is not implemented, when the current position is located within the function, it may be assumed that the exception handling block search unit 214a-1 detects the exception handling block. Alternatively, the portion outside the function may be excluded from the determination by the bytecode inspection unit 214g.

After step S102, the process proceeds to step S103.

(Step S103)

The function search unit 214f-1 searches for a function call after the current position.

In a case where the current position is located within the function, the function search unit 214f-1 may treat the position after the caller of the function as the position after the current position and search for a function call. This is relevant to the processing in the fifth example described above. In a case where the fifth example is not implemented, when the current position is located within the function, instead of assuming that the exception handling block search unit 214a-1 has detected the exception handling block, the function search unit 214f-1 may detect a function that is not on the whitelist. Alternatively, the portion outside the function may be excluded from the determination by the bytecode inspection unit 214g.

After step S103, the process proceeds to step S104.

(Step S104)

The preventive evaluation necessity determination unit 214g-1 determines whether the entire exception handling block is present after the current position. In a case where the exception handling block search unit 214a-1 detects the entire exception handling block after the current position in the processing of step S102, the preventive evaluation necessity determination unit 214g-1 determines that the entire exception handling block is present after the current position.

In step S103, also in a case where the function search unit 214f-1 detects a call of a function that is not on the whitelist after the current position, the preventive evaluation necessity determination unit 214g-1 determines that the entire exception handling block is present after the current position. This is relevant to the processing in the sixth case described above. In a case where the information processing device 100 does not include the whitelist storage unit 214f-2, when the function search unit 214f-1 detects a call of a function that is not on the whitelist after the current position, the preventive evaluation necessity determination unit 214g-1 may determine that the entire exception handling block is present after the current position. Alternatively, in a case where the sixth example is not implemented, the inside of the function called by the function call may be excluded from the determination target by the bytecode inspection unit 214g.

In a case where the preventive evaluation necessity determination unit 214g-1 determines that the entire exception handling block is present after the current position (step S104: YES), the process proceeds to step S111.

On the other hand, in a case where the preventive evaluation necessity determination unit 214g-1 determines that the entire exception handling block is not present after the current position (step S104: NO), the process proceeds to step S121.

(Step S111)

The bytecode inspection unit 214g determines whether to perform preventive evaluation at the current position for preventing erroneous detection.

After step S111, the information processing device 100 ends the processing of FIG. 22.

(Step S121)

The preventive evaluation necessity determination unit 214g-1 determines whether the current position is located within the try block. In a case where the exception handling block search unit 214a-1 detects a part of the try block immediately after the current position in the processing of step S102, the preventive evaluation necessity determination unit 214g-1 determines that the current position is located within the try block.

In a case where the preventive evaluation necessity determination unit 214g-1 determines that the current position is located within the try block (step S121: YES), the process proceeds to step S131.

On the other hand, in a case where the preventive evaluation necessity determination unit 214g-1 determines that the current position is not located within the try block (step S121: NO), the process proceeds to step S141.

(Step S131)

The bytecode inspection unit 214g determines whether to perform preventive evaluation at the current position for preventing overlooking.

After step S131, the information processing device 100 ends the processing of FIG. 22.

(Step S141)

The bytecode inspection unit 214g determines not to perform preventive evaluation at the current position.

After step S141, the information processing device 100 ends the processing of FIG. 22.

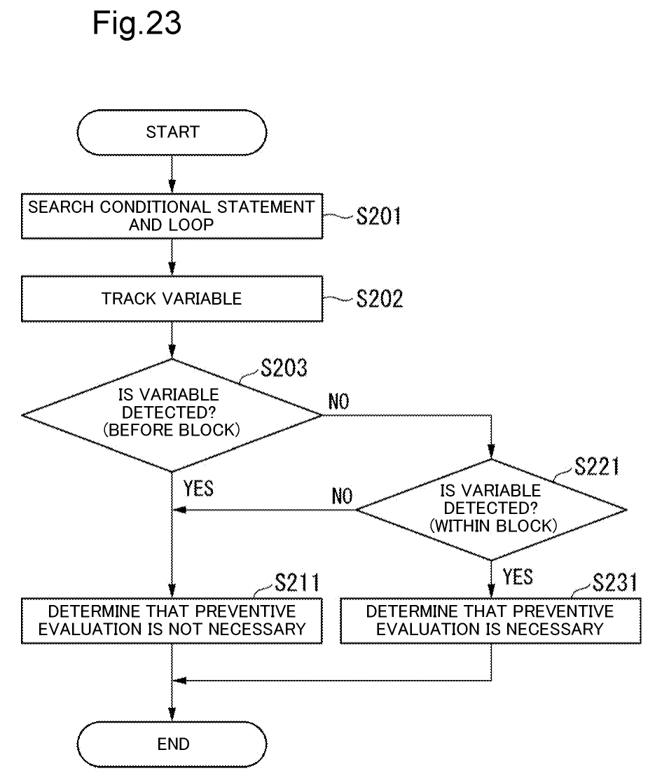

FIG. 23 is a diagram illustrating an example of a procedure of a process in which the bytecode inspection unit 214g determines whether to perform preventive evaluation at the current position for preventing erroneous detection. The bytecode inspection unit 214g performs the processing of FIG. 23 in step S111 of FIG. 22.

(Step S201)

The branch search unit 214d-1 searches for the conditional statement and the loop after the current position and before the exception handling block.

After step S201, the process proceeds to step S202.

(Step S202).

The in-exception-handling-block-variable tracking unit 214c-1 searches, after the current position, for a variable appearing at the current position.

After step S202, the process proceeds to step S203.

(Step S203).

The preventive evaluation necessity determination unit 214g-1 determines whether there is a chance that the variable appearing at the current position is evaluated after the current position and before the exception handling block. Specifically, the preventive evaluation necessity determination unit 214g-1 determines whether the variable appearing at the current position appears after the current position and before the exception handling block.

In a case where the branch search unit 214d-1 detects the conditional statement or the loop after the current position and before the exception handling block, the preventive evaluation necessity determination unit 214g-1 excludes the conditional statement or the loop from the determination target of whether there is a chance that the variable appearing at the current position is evaluated. That is, the preventive evaluation necessity determination unit 214g-1 determines whether there is a chance that the variable appearing at the current position is evaluated within the range after the current position and before the exception handling block and outside the conditional statement or the loop. This is relevant to the processing in the fourth example described above. In a case where the fourth example is not performed, the inside of the conditional statement and the inside of the loop may not be determined by the bytecode inspection unit 214g.

In a case where the preventive evaluation necessity determination unit 214g-1 determines that there is a chance that the variable appearing at the current position is evaluated after the current position and before the exception handling block (step S203: YES), the process proceeds to step S211.

On the other hand, in a case where the preventive evaluation necessity determination unit 214g-1 determines that there is no chance that the variable appearing at the current position is evaluated after the current position and before the exception handling block (step S203: NO), the process proceeds to step S221.

(Step S211)

The preventive evaluation necessity determination unit 214g-1 determines not to perform the preventive evaluation at the current position.

After step S211, the bytecode inspection unit 214g ends the processing of FIG. 23.

(Step S221)

The preventive evaluation necessity determination unit 214g-1 determines whether the variable appearing at the current position as the variable to be operated is evaluated in the exception handling block. Specifically, the preventive evaluation necessity determination unit 214g-1 determines whether a variable appearing at the current position as the variable to be operated or a variable whose value is obtained with reference to the variable appears within the exception handling block.

In a case where the preventive evaluation necessity determination unit 214g-1 determines that the variable appearing at the current position as the variable to be operated is evaluated in the exception handling block (step S221: YES), the process proceeds to step S231.

On the other hand, in a case where the preventive evaluation necessity determination unit 214g-1 determines that the variable appearing at the current position as the variable to be operated is not evaluated in the exception handling block (step S221: NO), the process proceeds to step S211.

(Step S231)

The preventive evaluation necessity determination unit 214g-1 determines to perform the preventive evaluation at the current position.

After step S231, the bytecode inspection unit 214g ends the processing of FIG. 23.

The processing in step S203 in FIG. 23 is relevant to the processing in the second example described above. In a case where the second process is not performed, the process may always proceed, in step S203, to step S221.

The processing in step S221 in FIG. 23 is relevant to the processing in the third example described above. In a case where the third process is not performed, the process may always proceed, in step S222, to step S231.

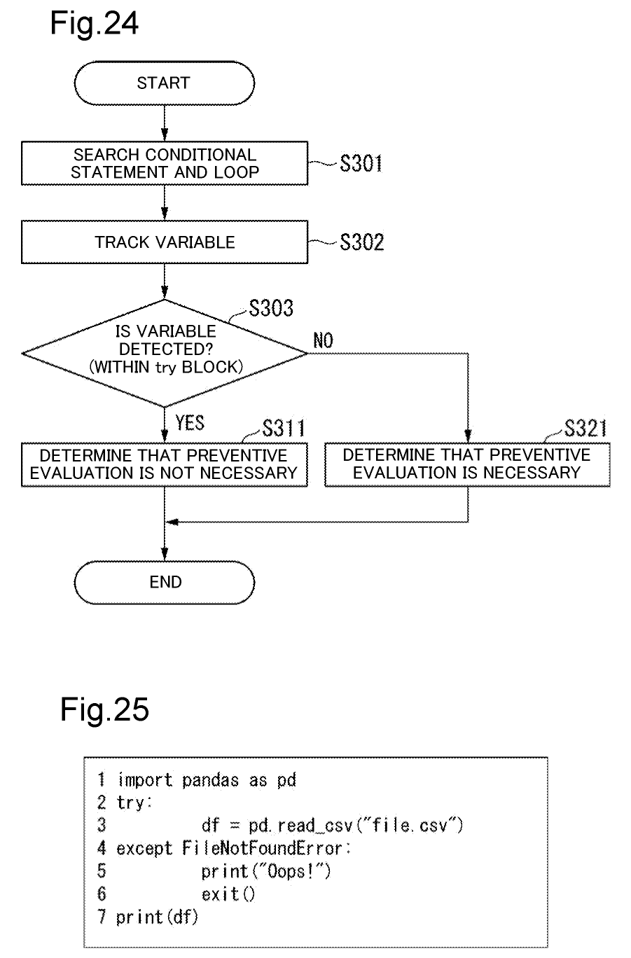

FIG. 24 is a diagram illustrating an example of a procedure of a process in which the bytecode inspection unit 214g determines whether to perform preventive evaluation at the current position for preventing overlooking. The bytecode inspection unit 214g performs the processing of FIG. 24 in step S131 of FIG. 22.

(Step S301)

The branch search unit 214d-1 searches for the conditional statement and the loop after the current position and within the try block.

After step S301, the process proceeds to step S302.

(Step S302)

The in-exception-handling-block-variable tracking unit 214c-1 searches for a variable appearing at the current position within the try block after the current position.

After step S302, the process proceeds to step S303.

(Step S303)

The preventive evaluation necessity determination unit 214g-1 determines whether there is a chance that the variable appearing at the current position is evaluated after the current position and within the try block. Specifically, the preventive evaluation necessity determination unit 214g-1 determines whether the variable appearing at the current position appears after the current position and within the try block.

In a case where the branch search unit 214d-1 detects the conditional statement or the loop after the current position and within the try block, the preventive evaluation necessity determination unit 214g-1 excludes the conditional statement or the loop from the determination target of whether there is a chance that the variable appearing at the current position is evaluated. That is, the preventive evaluation necessity determination unit 214g-1 determines whether there is a chance that the variable appearing at the current position is evaluated within the range after the current position and within the try block and outside the conditional statement or the loop. This is relevant to the processing in the fourth example described above. In a case where the fourth example is not performed, the inside of the conditional statement and the inside of the loop may not be determined by the bytecode inspection unit 214g.

In a case where the preventive evaluation necessity determination unit 214g-1 determines that there is a chance that the variable appearing at the current position is evaluated after the current position and within the try block (step S303: YES), the process proceeds to step S311.

On the other hand, in a case where the preventive evaluation necessity determination unit 214g-1 determines that there is no chance that the variable appearing at the current position is evaluated after the current position and within the try block (step S303: NO), the process proceeds to step S321.

(Step S311)

The preventive evaluation necessity determination unit 214g-1 determines not to perform the preventive evaluation at the current position.

After step S311, the bytecode inspection unit 214g ends the processing of FIG. 24.

(Step S321)

The preventive evaluation necessity determination unit 214g-1 determines to perform the preventive evaluation at the current position.

After step S321, the bytecode inspection unit 214g ends the processing of FIG. 24.

The processing in step S303 in FIG. 24 is relevant to the processing in the second example described above. In a case where the second process is not performed, the process may always proceed, in step S303, to step S321.

FIG. 25 is a diagram illustrating a thirteenth example of the source program including the exception handling. In FIG. 25, line numbers are illustrated on the left side of the source program.

The second to sixth lines are relevant to examples of the exception handling block. Among them, the second to third lines are relevant to an example of the try block, and the fourth to sixth lines are relevant to an example of the except block.

“df = pd.read_csv(“file.csv”)” in the third line indicates that a CSV file having a file name “file.csv” is read and substituted into the variable df.

“FileNotFoudError” on the fourth line indicates that processing indicated in the except block from the fourth line to the sixth line is performed when an exception that a file is not found occurs in the try block from the second line to the third line. Specifically, “print(“Oops!”)” in the fifth line is executed.

“exit()” in the sixth line is relevant to the end of the exception handling block (the end of the exception handling block).

“print(df)” in the seventh line indicates that the value of the variable df is output, for example, the value of the variable df is displayed.

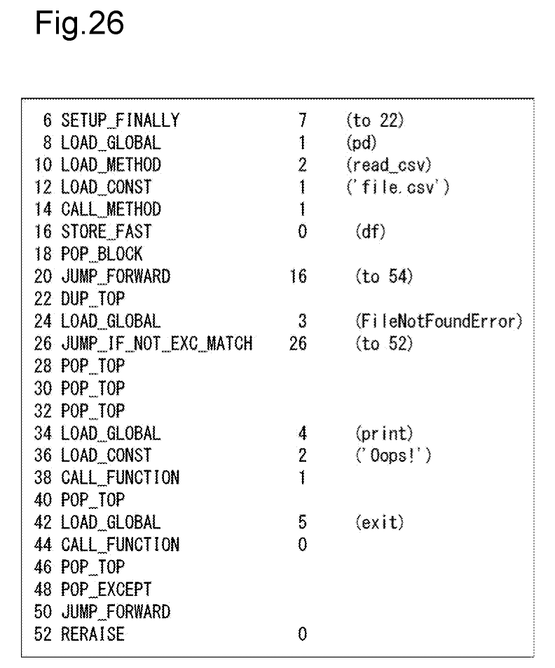

FIG. 26 is a diagram illustrating an example of assembly language-like display of a bytecode into which a source program is converted. In FIG. 26, bytecodes obtained by converting the second line to the sixth line of the source program of FIG. 25 are illustrated as in an assembly language.

In FIG. 26, the position of the bytecode (the address of the bytecode) is indicated by the number of bytes on the left side of the bytecode. Hereinafter, this number is also referred to as a label, and is used to designate a position in a bytecode. For example, a line showing “6” is also referred to as a label 6.

When the third line in FIG. 25 is the current position, the bytecode acquisition unit 213 acquires bytecodes relevant to the first to seventh lines. Specifically, the bytecode acquisition unit 213 acquires a stack frame other than read_csv according to “read_csv” in the third line, and acquires a bytecode from the stack frame.

In this case, in the bytecode of FIG. 26, “CALL_METHOD” of the label 14 is the current position.

The bytecode inspection unit 214 refers to the bytecode in FIG. 26, detects “SET_FINALLY” at the position of the label 6 before the label 14 that is the current position, and determines that the current position is located in the try block.

The bytecode inspection unit 214 detects “JUMP_IF_NOT_EXC_MATCH” at the position of the label 26, and determines that the try block ends at “JUMP_IF_NOT_EXC_MATCH” at the position of the label 20 before “JUMP_IF_NOT_EXC_MATCH”.

The bytecode inspection unit 214 determines that the preventive evaluation is necessary, and sets a flag indicating that the preventive evaluation is performed at the current position (sets a flag).

The intermediate representation generation unit 212 generates an intermediate representation relevant to read_csv appearing at the current position.

The evaluation unit 215 determines to perform evaluation at the current position with reference to the flag set by the bytecode inspection unit 214. Specifically, the evaluation unit 215 reads the file by read_csv in the third line in FIG. 25 by executing the intermediate representation generated by the intermediate representation generation unit 212.

Reading a file by read_csv and substituting the read file for the variable df are relevant to an example of evaluating the variable df.

In this manner, the variable appearing within the try block is evaluated in the try block. As a result, in a case where an exception occurs at the time of evaluating the variable, the processing indicated in the except block is executed.

In the examples of FIGS. 25 and 26, in a case where a file having the file name “file.csv” does not exist in reading of the file by read_csv on the third line of FIG. 25, the process (“print(“Oops!”)” in the fifth line) indicated in the except block on the fourth to sixth lines is executed.

On the other hand, in a case where the file having the file name “file.csv” exists, the file is successfully read, and the read data is substituted into the variable df. As a result, the information processing device 100 normally ends the operations of the exception handling blocks from the second line to the sixth line in FIG. 25.

As described above, in a case where it is determined that the entire exception handling block is present on the side in the progressing direction of program execution with respect to the current position in the program execution by the lazy evaluation method, or the current position is positioned within the exception detection target portion (try block) of the exception handling block, the bytecode inspection unit 214 performs a process of detecting, from the current position, the evaluation target variable at the current position.

In a case where the evaluation target variable is detected, the evaluation unit 215 evaluates the variable.

According to the information processing device 100, in a case where a program is executed by the lazy evaluation, exception handling can be performed similarly to the case of sequential execution.

Specifically, the information processing device 100 can detect a case where the entire exception handling block is present on the side in the progressing direction of program execution with respect to the current position as a scene where there is a possibility of erroneous detection. Then, by detecting a variable that needs to be evaluated from the current position and performing evaluation, the information processing device 100 can prevent the exception handling from being different between the lazy evaluation and the sequential execution of the program due to the occurrence of erroneous detection.

The information processing device 100 can detect a case where the current position is located within the exception detection target portion of the exception handling block as a scene that may be overlooked. Then, by detecting a variable that needs to be evaluated from the current position and performing evaluation, the information processing device 100 can prevent the exception handling from being different between the lazy evaluation and the sequential execution of the program due to the occurrence of overlooking.

In a case where it is determined that the entire exception handling block is present on the side in the progressing direction of program execution with respect to the current position and the variable appearing at the current position as the variable to be operated appears on the side in the progressing direction of program execution with respect to the current position and on the current position side with respect to the start position of the exception handling block, the bytecode inspection unit 214 determines that the variable is not to be evaluated at the current position. In a case where it is determined that the current position is located within the exception detection target portion (try block) of the exception handling block, and the variable appearing at the current position as the variable to be operated appears up to the end position of the exception detection target portion on the side in the progressing direction of program execution with respect to the current position, the bytecode inspection unit 214 determines that the variable is not to be evaluated at the current position.

According to the information processing device 100, in a case where there is a chance that the variable appearing at the current position as the variable to be operated is evaluated up to a predetermined position on the side in the progressing direction of program execution with respect to the current position, the evaluation of the variable can be delayed. The possibility that the information processing device 100 can optimize the intermediate representation regarding the variable can be increased by delaying the evaluation of the variable.

In a case where it is determined that the entire exception handling block is present on the side in the progressing direction of program execution with respect to the current position, the conditional statement or the loop is located on the side in the progressing direction of program execution with respect to the current position and on the current position side with respect to the start position of the exception handling block, and the variable appearing at the current position as the variable to be operated appears on the current position side with respect to the start position of the exception handling block and outside the conditional statement or the loop on the side in the progressing direction of program execution with respect to the current position, the bytecode inspection unit 214 determines that the variable is outside the target for evaluation at the current position. In a case where it is determined that the current position is located within the exception detection target portion (try block) of the exception handling block, a conditional statement or a loop is present up to the exception detection target portion on the side in the progressing direction of program execution with respect to the current position, and the variable appearing at the current position as the variable to be operated appears up to the end position of the exception detection target portion on the side in the progressing direction of program execution with respect to the current position and outside the conditional statement or the loop, the bytecode inspection unit 214 determines that the variable is not to be evaluated at the current position.

According to the information processing device 100, the conditional statement and the loop can be excluded from the determination target of the chance of evaluating the variable appearing at the current position. According to the information processing device 100, in this respect, it is possible to determine the necessity of the preventive evaluation with high accuracy.

In a case where it is determined that the entire exception handling block is present on the side in the progressing direction of program execution with respect to the current position and the variable appearing at the current position as the variable to be operated does not appear within the exception handling block, the bytecode inspection unit 214 determines that the variable is not to be evaluated at the current position.

According to the information processing device 100, in a case where the variable appearing at the current position is not evaluated within the exception handling block, the evaluation of the variable can be delayed. The possibility that the information processing device 100 can optimize the intermediate representation regarding the variable can be increased by delaying the evaluation of the variable.

In a case where the current position is located within the function, the bytecode inspection unit 214 determines whether to detect the variable appearing at the current position as the variable to be operated as the evaluation target variable at the current position based on the side in the progressing direction of the program with respect to the caller of the function in addition to the side in the progressing direction of the program with respect to the current position in the function.

According to the information processing device 100, it is possible to determine the necessity of the preventive evaluation in consideration of the caller of the function in which the current position is located. According to the information processing device 100, in this respect, it is possible to determine the necessity of the preventive evaluation with high accuracy.

The bytecode inspection unit 214 determines whether to detect, as the evaluation target variable at the current position, a variable appearing at the current position as the variable to be operated based on the side in the progressing direction of the program with respect to each caller after tracing the caller of the function from the function at the current position to the uppermost function.

According to the information processing device 100, in a case where function calls are nested, it is possible to determine the necessity of preventive evaluation in consideration of the caller of each function. According to the information processing device 100, in this respect, it is possible to determine the necessity of the preventive evaluation with high accuracy.

In a case where the function call having, as an argument, the variable appearing at the current position as the variable to be operated is on the side in the progressing direction of program execution with respect to the current position, and the function to be called is not indicated in the whitelist indicating the function not including the exception handling block, the bytecode inspection unit 214 detects the variable as the evaluation target variable at the current position.

According to the information processing device 100, it is possible to determine the necessity of the preventive evaluation in consideration of whether the called function includes the exception handling block.

According to the information processing device 100, in this respect, it is possible to determine the necessity of the preventive evaluation with high accuracy.

According to the information processing device 100, it is not necessary to analyze the inside of the called function by using the whitelist. According to the information processing device 100, in this respect, a load of determining the necessity of the preventive evaluation is expected to be small, and even in a case where the inside of the called function cannot be referred to, it is possible to determine the necessity of the preventive evaluation with high accuracy.

The bytecode inspection unit 214 detects all variables operated at the current position as evaluation target variables at the current position.

According to the information processing device 100, it is possible to determine whether the preventive evaluation is necessary by determining whether the entire exception handling block is present on the side in the progressing direction of program execution with respect to the current position or whether the current position is located within the exception detection target portion of the exception handling block. According to the information processing device 100, in this respect, it is expected that the load of determining the necessity of the preventive evaluation is small.

### Second Example Embodiment

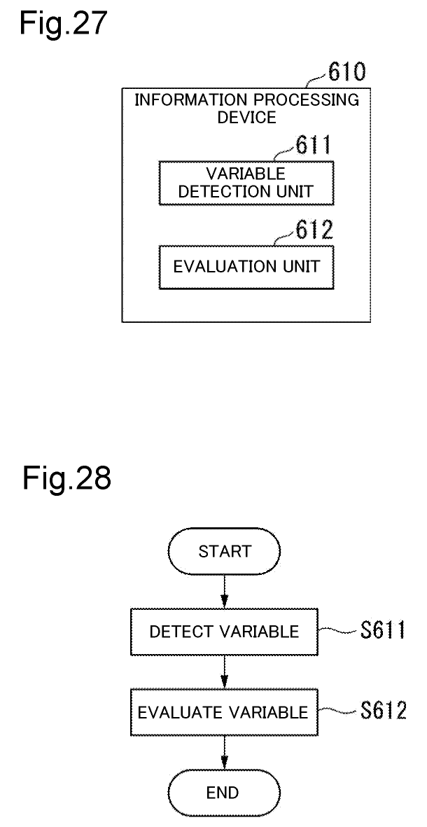

FIG. 27 is a diagram illustrating an example of a configuration of an information processing device according to at least one example embodiment.

In the configuration illustrated in FIG. 27, an information processing device 610 includes a variable detection unit 611 and an evaluation unit 612.

With such a configuration, in a case where it is determined that the entire exception handling block is present on the side in the progressing direction of program execution with respect to the current position in the program execution by the lazy evaluation method, or the current position is positioned within the exception detection target portion of the exception handling block, the variable detection unit 611 performs a process of detecting, from the current position, the evaluation target variable at the current position.

In a case where the evaluation target variable is detected, the evaluation unit 612 evaluates the variable.

The variable detection unit 611 is relevant to an example of a variable detection means. The evaluation unit 612 is relevant to an example of an evaluation means.

According to the information processing device 610, in a case where a program is executed by the lazy evaluation, exception handling can be performed similarly to the case of sequential execution.

Specifically, the information processing device 610 can detect a case where the entire exception handling block is present on the side in the progressing direction of program execution with respect to the current position as a scene where there is a possibility of erroneous detection. Then, by detecting a variable that needs to be evaluated from the current position and performing evaluation, the information processing device 610 can prevent the exception handling from being different between the lazy evaluation and the sequential execution of the program due to the occurrence of erroneous detection. The erroneous detection mentioned here is that evaluation of a variable indicated outside the try block (the exception detection target portion of the exception handling block) is performed in the try block.

The information processing device 610 can detect a case where the current position is located within the exception detection target portion of the exception handling block as a scene that may be overlooked. Then, by detecting a variable that needs to be evaluated from the current position and performing evaluation, the information processing device 610 can prevent the exception handling from being different between the lazy evaluation and the sequential execution of the program due to the occurrence of overlooking. The overlooking here is that the evaluation of the variable indicated within the try block is performed outside the try block.

### Third Example Embodiment

FIG. 28 is a diagram illustrating an example of processing in an information processing method according to at least one example embodiment. The information processing method illustrated in FIG. 28 includes detecting a variable (step S611) and evaluating the variable (step S612).

In the detecting of the variable (step S611), in a case where it is determined that the entire exception handling block is present on the side in the progressing direction of program execution with respect to the current position in the program execution by the lazy evaluation method, or the current position is positioned within the exception detection target portion of the exception handling block, a computer performs a process of detecting, from the current position, the evaluation target variable at the current position.

In the evaluating of the variable (step S612), in a case where the evaluation target variable is detected, the computer evaluates the variable.

According to the information processing method illustrated in FIG. 28, in a case where a program is executed by the lazy evaluation, exception handling can be performed similarly to the case of sequential execution.

Specifically, according to the information processing method illustrated in FIG. 28, it is possible to detect a case where the entire exception handling block is present on the side in the progressing direction of program execution with respect to the current position as a scene where there is a possibility of erroneous detection. Then, according to the information processing method illustrated in FIG. 28, by detecting a variable that needs to be evaluated from the current position and performing evaluation, it is possible to prevent the exception handling from being different between the lazy evaluation and the sequential execution of the program due to the occurrence of erroneous detection. The erroneous detection mentioned here is that evaluation of a variable indicated outside the try block (the exception detection target portion of the exception handling block) is performed in the try block.

According to the information processing method illustrated in FIG. 28, it is possible to detect a case where the current position is located within the exception detection target portion of the exception handling block as a scene that may be overlooked. Then, according to the information processing method illustrated in FIG. 28, by detecting a variable that needs to be evaluated from the current position and performing evaluation, it is possible to prevent the exception handling from being different between the lazy evaluation and the sequential execution of the program due to the occurrence of overlooking. The overlooking here is that the evaluation of the variable indicated within the try block is performed outside the try block.

One of the program execution methods is Lazy Evaluation. In a case where the program is executed by the lazy evaluation, if the exception handling can be performed similarly to the case of the sequential execution, the user does not need to be aware of the exception handling specific to the lazy evaluation when preparing the source program, and in this respect, the burden on the user can be reduced.

An object of the present disclosure is to provide an information processing device, an information processing method, a program that can solve the above-described problem.

According to an aspect of the present disclosure, when a program is executed by the lazy evaluation, exception handling can be performed similarly to the case of sequential execution.

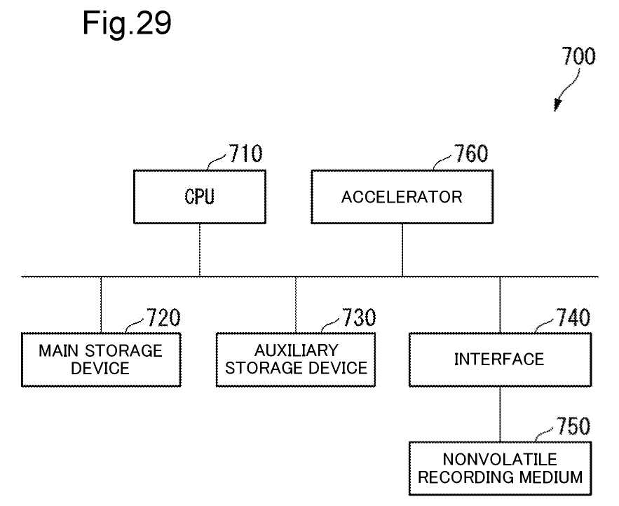

FIG. 29 is a diagram illustrating an example of a configuration of a computer according to at least one example embodiment.

In the configuration illustrated in FIG. 29, a computer 700 includes a CPU 710, a main storage device 720, an auxiliary storage device 730, an interface 740, a nonvolatile recording medium 750, and an accelerator 760.

Any one or more of the information processing device 100 and the information processing device 610 or a part thereof may be implemented in the computer 700. In this case, the operation of each processing unit described above is stored in the auxiliary storage device 730 in the form of a program. The CPU 710 and the accelerator 760 read the program from the auxiliary storage device 730, load the program in the main storage device 720, and execute the above processing according to the program. The CPU 710 secures a storage area related to each of the above-described storage units in the main storage device 720 according to the program.

Communication between each device and another device is executed by the interface 740 having a communication function and performing communication under the control of the CPU 710. The interface 740 has a port for the nonvolatile recording medium 750, and reads information from the nonvolatile recording medium 750 and writes information to the nonvolatile recording medium 750.

In a case where the information processing device 100 is mounted in the computer 700, the operation of the processing unit 190 and each unit thereof is stored in the auxiliary storage device 730 in the form of a program. The CPU 710 and the accelerator 760 read the program from the auxiliary storage device 730, load the program in the main storage device 720, and execute the above processing according to the program.

The CPU 710 secures a storage area for the storage unit 180 in the main storage device 720 according to the program. Communication with another device by the communication unit 110 is executed by the operation of the interface 740 having a communication function under the control of the CPU 710. The display of the image by the display unit 120 is executed by the interface 740 including a display device and displaying various images under the control of the CPU 710. The operation input unit 130 receives a user operation by the interface 740 including an input device to receive the user operation under the control of the CPU 710.

In a case where the information processing device 610 is mounted in the computer 700, the operations of the variable detection unit 611 and the evaluation unit 612 are stored in the auxiliary storage device 730 in the form of a program. The CPU 710 and the accelerator 760 read the program from the auxiliary storage device 730, load the program in the main storage device 720, and execute the above processing according to the program.

The CPU 710 secures a storage area for the information processing device 610 to perform processing in the main storage device 720 according to the program. Communication between the information processing device 610 and another device is executed by the operation of the interface 740 having a communication function under the control of the CPU 710. The interaction between the information processing device 610 and the user is executed by the interface 740, including an input device and an output device, in which the output device presents information to the user according to the control of the CPU 710, and the input device receives a user operation.

Any one or more of the above-described programs may be recorded in the nonvolatile recording medium 750. In this case, the interface 740 may read the program from the nonvolatile recording medium 750. The CPU 710 and the accelerator 760 may directly execute the program read by the interface 740, or may temporarily store the program in the main storage device 720 or the auxiliary storage device 730 and execute the program.

A program for executing all or part of the processing performed by the information processing device 100 and the information processing device 610 may be recorded in a computer-readable recording medium, and the processing of each unit may be performed by causing a computer system to read and execute the program recorded in the recording medium. The “computer system” herein includes an operating system (OS) and hardware such as peripheral devices.

The “computer-readable recording medium” refers to a portable medium such as a flexible disk, a magneto-optical disk, a read only memory (ROM), and a compact disc read only memory (CD-ROM), and a storage device such as a hard disk built in a computer system. The program may be for implementing some of the functions described above, and the functions described above may be implemented in combination with a program already recorded in the computer system.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Some or all of the above example embodiments may also be described as, but are not limited to, the following Supplementary Notes.

### Supplementary Note 1

An information processing device including:

a variable detection means for performing a process of detecting, from a current position, an evaluation target variable at the current position in a case where it is determined that an entire exception handling block is present on a side in a progressing direction of program execution with respect to the current position in program execution by a lazy evaluation method or the current position is located within an exception detection target portion of the exception handling block; and

an evaluation means for evaluating a variable in a case where the evaluation target variable is detected.

### Supplementary Note 2

The information processing device according to Supplementary Note 1, in which

the variable detection means is configured to execute:

determining that a variable is not to be evaluated at the current position in a case where it is determined that the entire exception handling block is present on the side in the progressing direction of program execution with respect to the current position, and the variable appearing at the current position as a variable to be operated appears on the side in the progressing direction of program execution with respect to the current position and on the current position side with respect to a start position of the exception handling block; and

determining that a variable is not to be evaluated at the current position in a case where it is determined that the current position is located within the exception detection target portion of the exception handling block and the variable appearing at the current position as a variable to be operated appears up to an end position of the exception detection target portion on the side in the progressing direction of program execution with respect to the current position.

### Supplementary Note 3

The information processing device according to Supplementary Note. 1, in which

the variable detection means is configured to execute:

determining that a variable is not to be evaluated at the current position in a case where it is determined that the entire exception handling block is present on the side in the progressing direction of program execution with respect to the current position, a conditional statement or a loop is present on the side in the progressing direction of program execution with respect to the current position and on the current position side with respect to a start position of the exception handling block, and the variable appearing at the current position as a variable to be operated appears on the side in the progressing direction of program execution with respect to the current position, on the current position side with respect to the start position of the exception handling block, and outside the conditional statement or the loop; and

determining that the variable is not to be evaluated at the current position in a case where it is determined that the current position is located within the exception detection target portion of the exception handling block, a conditional statement or a loop is present up to the exception detection target portion on the side in the progressing direction of program execution with respect to the current position, and the variable appearing at the current position as a variable to be operated appears up to an end position of the exception detection target portion on the side in the progressing direction of program execution with respect to the current position and out of the conditional statement or the loop.

### Supplementary Note 4

The information processing device according to any one of Supplementary Notes 1 to 3, in which

the variable detection means is configured to execute:

determining that a variable is not to be evaluated at the current position in a case where it is determined that the entire exception handling block is present on the side in the progressing direction of program execution with respect to the current position, and a variable appearing at the current position as a variable to be operated does not appear within the exception handling block.

### Supplementary Note 5

The information processing device according to any one of Supplementary Notes 1 to 4, in which

the variable detection means is configured to execute: determining, in a case where the current position is located within a function, whether to detect a variable appearing at the current position as a variable to be operated as an evaluation target variable at the current position based on a side in a program progressing direction with respect to a caller of the function in addition to a side in the program progressing direction with respect to the current position in the function.

### Supplementary Note 6

The information processing device according to Supplementary Note 5, in which

the variable detection means is configured to execute following a function caller from a function at the current position to an uppermost function, and determining whether to detect a variable appearing at the current position as a variable to be operated as an evaluation target variable at the current position based on a side in a progressing direction of a program with respect to each caller.

### Supplementary Note 7

The information processing device according to any one of Supplementary Notes 1 to 6, in which

the variable detection means is configured to execute detecting a variable as an evaluation target variable at the current position in a case where a function call having, as an argument, a variable appearing at the current position as a variable to be operated is on a side in a progressing direction of program execution with respect to the current position and a called function is not indicated in a whitelist indicating a function not including an exception handling block.

### Supplementary Note 8

The information processing device according to Supplementary Note 1, in which

the variable detection means is configured to execute detecting all variables operated at the current position as evaluation target variables at the current position.

### Supplementary Note 9

An information processing method for causing a computer to execute:

performing a process of detecting, from a current position, an evaluation target variable at the current position in a case where it is determined that an entire exception handling block is present on a side in a progressing direction of program execution with respect to the current position in program execution by a lazy evaluation method or the current position is located within an exception detection target portion of the exception handling block; and

evaluating a variable in a case where the evaluation target variable is detected.

### Supplementary Note 10

The information processing method according to Supplementary Note 9, in which

in the process of detecting, the computer executes:

determining that a variable is not to be evaluated at the current position in a case where it is determined that the entire exception handling block is present on the side in the progressing direction of program execution with respect to the current position, and the variable appearing at the current position as a variable to be operated appears on the side in the progressing direction of program execution with respect to the current position and on the current position side with respect to a start position of the exception handling block; and

determining that a variable is not to be evaluated at the current position in a case where it is determined that the current position is located within the exception detection target portion of the exception handling block and the variable appearing at the current position as a variable to be operated appears up to an end position of the exception detection target portion on the side in the progressing direction of program execution with respect to the current position.

### Supplementary Note 11

The information processing method according to Supplementary Note 9, in which

in the process of detecting, the computer executes:

determining that a variable is not to be evaluated at the current position in a case where it is determined that the entire exception handling block is present on the side in the progressing direction of program execution with respect to the current position, a conditional

statement or a loop is present on the side in the progressing direction of program execution with respect to the current position and on the current position side with respect to a start position of the exception handling block, and the variable appearing at the current position as a variable to be operated appears on the side in the progressing direction of program execution with respect to the current position, on the current position side with respect to the start position of the exception handling block, and outside the conditional statement or the loop; and

determining that the variable is not to be evaluated at the current position in a case where it is determined that the current position is located within the exception detection target portion of the exception handling block, a conditional statement or a loop is present up to the exception detection target portion on the side in the progressing direction of program execution with respect to the current position, and the variable appearing at the current position as a variable to be operated appears up to an end position of the exception detection target portion on the side in the progressing direction of program execution with respect to the current position and out of the conditional statement or the loop.

### Supplementary Note 12

The information processing method according to any one of Supplementary Notes 9 to 11, in which

in the process of detecting, the computer executes:

determining that a variable is not to be evaluated at the current position in a case where it is determined that the entire exception handling block is present on the side in the progressing direction of program execution with respect to the current position, and a variable appearing at the current position as a variable to be operated does not appear within the exception handling block.

### Supplementary Note 13

The information processing method according to any one of Supplementary Notes 9 to 12, in which

in the process of detecting, the computer executes:

determining, in a case where the current position is located within a function, whether to detect a variable appearing at the current position as a variable to be operated as an evaluation target variable at the current position based on a side in a program progressing direction with respect to a caller of the function in addition to a side in the program progressing direction with respect to the current position in the function.

### Supplementary Note 14

The information processing method according to Supplementary Note 13, in which

in the process of detecting, the computer executes

following a function caller from a function at the current position to an uppermost function, and determining whether to detect a variable appearing at the current position as a variable to be operated as an evaluation target variable at the current position based on a side in a progressing direction of a program with respect to each caller.

### Supplementary Note 15

The information processing method according to any one of Supplementary Notes 9 to 14, in which

in the process of detecting, the computer executes

detecting a variable as an evaluation target variable at the current position in a case where a function call having, as an argument, a variable appearing at the current position as a variable to be operated is on the side in the progressing direction of program execution with respect to the current position and a called function is not indicated in a whitelist indicating a function not including an exception handling block.

### Supplementary Note 16

The information processing method according to Supplementary Note 9, in which

in the process of detecting, the computer executes

detecting all variables operated at the current position as evaluation target variables at the current position.

### Supplementary Note 17

A program for causing a computer to execute:

performing a process of detecting, from a current position, an evaluation target variable at the current position in a case where it is determined that an entire exception handling block is present on a side in a progressing direction of program execution with respect to the current position in program execution by a lazy evaluation method or the current position is located within an exception detection target portion of the exception handling block; and

evaluating a variable in a case where the evaluation target variable is detected.

### Supplementary Note 18

The program according to Supplementary Note 17, which

in the process of detecting, the computer executes:

determining that a variable is not to be evaluated at the current position in a case where it is determined that the entire exception handling block is present on the side in the progressing direction of program execution with respect to the current position, and the variable appearing at the current position as a variable to be operated appears on the side in the progressing direction of program execution with respect to the current position and on the current position side with respect to a start position of the exception handling block; and

determining that a variable is not to be evaluated at the current position in a case where it is determined that the current position is located within the exception detection target portion of the exception handling block and the variable appearing at the current position as a variable to be operated appears up to an end position of the exception detection target portion on the side in the progressing direction of program execution with respect to the current position.

### Supplementary Note 19

The program according to Supplementary Note 17, in which

in the process of detecting, the computer executes:

determining that a variable is not to be evaluated at the current position in a case where it is determined that the entire exception handling block is present on the side in the progressing direction of program execution with respect to the current position, a conditional statement or a loop is present on the side in the progressing direction of program execution with respect to the current position and on the current position side with respect to a start position of the exception handling block, and the variable appearing at the current position as a variable to be operated appears on the side in the progressing direction of program execution with respect to the current position, on the current position side with respect to the start position of the exception handling block, and outside the conditional statement or the loop; and

determining that the variable is not to be evaluated at the current position in a case where it is determined that the current position is located within the exception detection target portion of the exception handling block, a conditional statement or a loop is present up to the exception detection target portion on the side in the progressing direction of program execution with respect to the current position, and the variable appearing at the current position as a variable to be operated appears up to an end position of the exception detection target portion on the side in the progressing direction of program execution with respect to the current position and out of the conditional statement or the loop.

### Supplementary Note 20

The program according to any one of Supplementary Notes 17 to 19, in which

in the process of detecting, the computer executes:

determining that a variable is not to be evaluated at the current position in a case where it is determined that the entire exception handling block is present on the side in the progressing direction of program execution with respect to the current position, and a variable appearing at the current position as a variable to be operated does not appear within the exception handling block.

### Supplementary Note 21

The program according to any one of Supplementary Notes 17 to 20, in which

in the process of detecting, the computer executes:

determining, in a case where the current position is located within a function, whether to detect a variable appearing at the current position as a variable to be operated as an evaluation target variable at the current position based on a side in a program progressing direction with respect to a caller of the function in addition to a side in the program progressing direction with respect to the current position in the function.

### Supplementary Note 22

The program according to Supplementary Note 21, in which

in the process of detecting, the computer executes

following a function caller from a function at the current position to an uppermost function, and determining whether to detect a variable appearing at the current position as a variable to be operated as an evaluation target variable at the current position based on a side in a progressing direction of a program with respect to each caller.

### Supplementary Note 23

The program according to any one of Supplementary Notes 17 to 22, in which

in the process of detecting, the computer executes

detecting a variable as an evaluation target variable at the current position in a case where a function call having, as an argument, a variable appearing at the current position as a variable to be operated is on the side in the progressing direction of program execution with respect to the current position and a called function is not indicated in a whitelist indicating a function not including an exception handling block.

### Supplementary Note 24

The program according to Supplementary Note 17, in which

in the process of detecting, the computer executes

detecting all variables operated at the current position as evaluation target variables at the current position.

1. An information processing device comprising:
a memory; and
at least one processor coupled to the memory,
the at least one processor performing operations to:
perform a process of detecting, from a current position, an evaluation target variable at the current position in a case where it is determined that an entire exception handling block is present on a side in a progressing direction of program execution with respect to the current position in program execution by a lazy evaluation method or the current position is located within an exception detection target portion of the exception handling block; and
evaluate a variable in a case where the evaluation target variable is detected.

2. The information processing device according to claim 1, wherein
the at least one processor performing operations to:
determine that a variable is not to be evaluated at the current position in a case where it is determined that the entire exception handling block is present on the side in the progressing direction of program execution with respect to the current position, and the variable appearing at the current position as a variable to be operated appears on the side in the progressing direction of program execution with respect to the current position and on the current position side with respect to a start position of the exception handling block; and
determine that a variable is not to be evaluated at the current position in a case where it is determined that the current position is located within the exception detection target portion of the exception handling block and the variable appearing at the current position as a variable to be operated appears up to an end position of the exception detection target portion on the side in the progressing direction of program execution with respect to the current position.

3. The information processing device according to claim 1, wherein
the at least one processor performing operations to:
determine that a variable is not to be evaluated at the current position in a case where it is determined that the entire exception handling block is present on the side in the progressing direction of program execution with respect to the current position, a conditional statement or a loop is present on the side in the progressing direction of program execution with respect to the current position and on the current position side with respect to a start position of the exception handling block, and the variable appearing at the current position as a variable to be operated appears on the side in the progressing direction of program execution with respect to the current position, on the current position side with respect to the start position of the exception handling block, and outside the conditional statement or the loop; and
determine that a variable is not to be evaluated at the current position in a case where it is determined that the current position is located within the exception detection target portion of the exception handling block, a conditional statement or a loop is present up to the exception detection target portion on the side in the progressing direction of program execution with respect to the current position, and the variable appearing at the current position as a variable to be operated appears up to an end position of the exception detection target portion on the side in the progressing direction of program execution with respect to the current position and out of the conditional statement or the loop.

4. The information processing device according to claim 1, wherein
the at least one processor performing operations to:
determine that a variable is not to be evaluated at the current position in a case where it is determined that the entire exception handling block is present on the side in the progressing direction of program execution with respect to the current position, and a variable appearing at the current position as a variable to be operated does not appear within the exception handling block.

5. The information processing device according to claim 1, wherein
the at least one processor performing operations to:
determine, in a case where the current position is located within a function, whether to detect a variable appearing at the current position as a variable to be operated as an evaluation target variable at the current position based on a side in a program progressing direction with respect to a caller of the function in addition to a side in the program progressing direction with respect to the current position in the function.

6. The information processing device according to claim 5, wherein
the at least one processor performing operations to:
follow a function caller from a function at the current position to an uppermost function, and determining whether to detect a variable appearing at the current position as a variable to be operated as an evaluation target variable at the current position based on the side in the progressing direction of a program with respect to each caller.

7. The information processing device according to claim 1, wherein
the at least one processor performing operations to:
detect a variable as an evaluation target variable at the current position in a case where a function call having, as an argument, a variable appearing at the current position as a variable to be operated is on the side in the progressing direction of program execution with respect to the current position and a called function is not indicated in a whitelist indicating a function not including an exception handling block.

8. The information processing device according to claim 1, wherein
the at least one processor performing operations to:
detect all variables operated at the current position as evaluation target variables at the current position.

9. An information processing method for causing a computer to execute:
performing a process of detecting, from a current position, an evaluation target variable at the current position in a case where it is determined that an entire exception handling block is present on a side in a progressing direction of program execution with respect to the current position in program execution by a lazy evaluation method or the current position is located within an exception detection target portion of the exception handling block; and
evaluating a variable in a case where the evaluation target variable is detected.

10. A non-transitory computer-readable storage medium storing a program causing a computer to execute a process comprising:
performing a process of detecting, from a current position, an evaluation target variable at the current position in a case where it is determined that an entire exception handling block is present on a side in a progressing direction of program execution with respect to the current position in program execution by a lazy evaluation method or the current position is located within an exception detection target portion of the exception handling block; and
evaluating a variable in a case where the evaluation target variable is detected.
